(19) United States
(12) Patent Application Publication
(10) Pub. No.: US 2017/0316363 A1
(43) Pub. Date: Nov. 2, 2017

(54) TAILORED RECOMMENDATIONS FOR A WORKFLOW DEVELOPMENT SYSTEM

(71) Applicant: Microsoft Technology Licensing, LLC, Redmond, WA (US)

(72) Inventors: Stephen C. Siciliano, Bellevue, WA (US); Charles Lamanna, Bellevue, WA (US); Ilya V. Grebnov, Kirkland, WA (US); Sunay Vaishnav, Bellevue, WA (US)

(21) Appl. No.: 15/277,666

(22) Filed: Sep. 27, 2016

Related U.S. Application Data
(60) Provisional application No. 62/328,902, filed on Apr. 28, 2016.

(51) Int. Cl. G06Q 10/06; G06F 3/0482

(52) U.S. Cl. CPC G06Q 10/06316; G06F 3/0482

(57) ABSTRACT

A workflow development system is described herein that obtains information about a user and, based on at least the obtained information, recommends to the user applications and services around which to build workflows, workflow templates that can be used to quickly develop workflows, and workflow steps that can be included in a workflow under development. The workflow development system may also recommend workflow steps based on information concerning a workflow under development, such as information concerning previously-included workflow steps in the workflow under development. The workflow development system may also be configured to recommend one or more output parameters of one or more workflow steps of a workflow under development as an input parameter for another workflow step.

### CROSS-REFERENCE TO RELATED APPLICATIONS

This application claims the benefit of U.S. Provisional Patent Application No. 62/328,902, filed on Apr. 28, 2016, the entirety of which is incorporated by reference herein.

### BACKGROUND

A business or enterprise application is a computer program used by business users to perform various business functions. Business applications are frequently developed when available off-the-shelf software does not completely address the desired functionality. Many business applications are interactive, having a graphical user interface (GUI) via which users can input data, submit data queries, perform operations, and view results. Consumer applications are less business focused, instead being focused on the needs of the consumer.

Business and consumer users tend to depend on information technology (IT) personnel to code their applications due to application complexity, and the programming expertise required. For example, merely designing an application to retrieve data from a remote source (e.g., a cloud service) is difficult, typically requiring the involvement of an experienced software developer.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A workflow development system is described herein that obtains information about a user and, based on at least the obtained information, recommends to the user applications and services around which to build workflows, workflow templates that can be used to quickly develop workflows, and workflow steps to be included in a workflow under development. The workflow development system may also recommend workflow steps based on information concerning a workflow under development, such as information concerning previously-included workflow steps in the workflow under development. The workflow development system may also be configured to recommend one or more output parameters of one workflow step of a workflow under development as an input parameter for another workflow step.

Further features and advantages of the invention, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 is a block diagram of a workflow development system, according to an example embodiment.

FIG. 2 depicts a flowchart of a process for development of workflows, according to an example embodiment.

FIG. 3 is a block diagram of a workflow designer application, according to an example embodiment.

FIG. 4 is a block diagram of a display screen showing a browser window displaying an exemplary workflow, according to an example embodiment.

FIGS. 5-8 show views of an exemplary workflow in various phases of development using a workflow designer GUI, according to example embodiments.

FIG. 9 is a block diagram of a system for executing a workflow, according to an example embodiment.

FIG. 10 depicts a flowchart of a process for executing a user application that includes one or more workflows, according to an example embodiment.

FIG. 11 is a block diagram of a workflow development system in accordance with an embodiment that is capable of providing tailored recommendations to a user thereof regarding templates that can be used to generate workflows, applications and services around which workflows can be built, and workflow steps that may be included in a workflow under development.

FIG. 12 depicts a flowchart of a method for providing a user of a workflow development system with a set of recommended workflow templates for selection and configuration thereby, according to an example embodiment.

FIG. 13 shows an example view of a workflow designer GUI in which interactive graphical representations corresponding to a set of recommended workflow templates are displayed, according to an example embodiment.

FIG. 14 shows an example view of a workflow designer GUI via which a user of a workflow development system is enabled to customize a workflow template, according to an example embodiment.

FIG. 15 depicts a flowchart of a method for providing a user of a workflow development system with a set of recommended applications or services around which to build a workflow, according to an example embodiment.

FIG. 16 shows an example view of a workflow designer GUI in which interactive graphical representations of recommended applications and services around which a workflow may be built are displayed, according to an example embodiment.

FIG. 17 depicts a flowchart of a method for providing a user of a workflow development system with a set of recommended workflow steps for inclusion in a workflow under development, according to an example embodiment.

FIG. 18 shows an example view of a workflow designer GUI in which interactive graphical representations associated with a set of recommended workflow steps are displayed, according to an embodiment.

FIG. 19 shows another example view of a workflow designer GUI in which interactive graphical representations associated with a set of recommended workflow steps are displayed, according to an embodiment.

FIG. 20 depicts a flowchart of a method for providing a user of a workflow development system with a set of recommended output parameters of one or more first workflow steps so that the user can select one of the recommended output parameters as an input parameter for a second workflow step, according to an example embodiment.

FIG. 21 shows an example view of a workflow designer GUI in which interactive graphical representations of a set of recommended output parameters of a first workflow step are displayed, wherein a user can select one of the recommended output parameters as an input parameter to a second workflow step, according to an embodiment.

FIG. 22 is a block diagram of an example mobile device that may be used to implement various embodiments.

FIG. 23 is a block diagram of an example processor-based computer system that may be used to implement various embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of persons skilled in the relevant art(s) to implement such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Section II below will describe example embodiments for development of workflows. In particular, sub-sections A and B of Section II describe example workflow development embodiments and runtime embodiments, respectively. Subsection C of Section II describes example workflow development embodiments that are capable of providing tailored recommendations to a user thereof regarding applications and services around which to build workflows, workflow templates that can be used to quickly generate workflows, and workflow steps to be included in a workflow under development, and that are also capable of recommending output parameters of one workflow step of a workflow under development as potential input parameters of another workflow step of the workflow under development.

Section III below will describe an example mobile device that may be used to implement features of the embodiments described herein. Section IV below will describe an example processor-based computer system that may be used to implement features of the embodiments described herein. Section V below will describe some additional example embodiments. Section VI will provide some concluding remarks.

### II. Example Embodiments for Development of Workflows

Business applications and consumer applications are typically created when available off-the-shelf software does not completely address the desired functionality. Many business and consumer applications are interactive, having a GUI via which users can input data, submit data queries, perform operations, and view results.

Users tend to depend on IT personnel to code their applications due to application complexity and the programming expertise required. For instance, configuring an application to retrieve data from a source of interest to enterprises or consumers (e.g., data from an SQL (structured query language) database, customer relationship information from Salesforce.com of San Francisco, Calif., social network information from Facebook® operated by Facebook, Inc. of Palo Alto, Calif., or Twitter® operated by Twitter, Inc. of San Francisco, Calif.) is a difficult process.

Embodiments described herein enable easier development of applications, including business applications and consumer applications. Users are enabled to develop applications in the form of workflows without having to be expert programmers.

Example embodiments are described in the following subsections for development of applications in the form of workflows. In the following description, a person that develops an application using the techniques described herein may be referred to as a “developer” and a person that uses the application at runtime may be referred to as a “user” or “end user”. However, it is to be understood that the developer may also be considered a “user” of the workflow development system. Furthermore, a “developer,” as referred to herein, does not need to have any expertise in computer programming. Various embodiments described herein enable application development without special programming skills.

### A. Example Workflow Development Embodiments

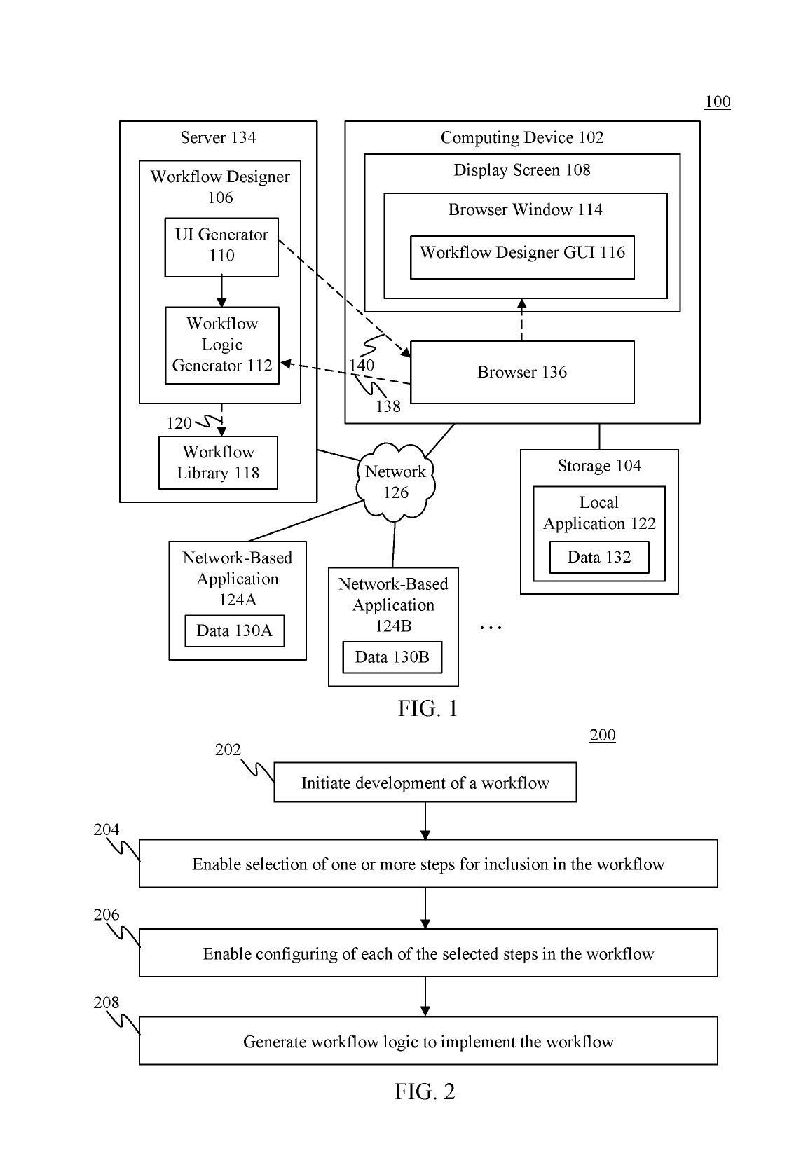

Development of workflows may be enabled in various ways in embodiments. For instance, FIG. 1 is a block diagram of a workflow development system 100, according to an example embodiment. As shown in FIG. 1, system 100 includes a computing device 102, storage 104, a first network-based application 124A, a second network-based application 124B, and a server 134. Server 134 includes a workflow designer 106 and a workflow library 118 (e.g., in storage). Computing device 102 includes a display screen 108 and a browser 136. Storage 104 stores a local application 122. System 100 is described as follows.

Computing device 102 may be any type computing device, including a mobile computing device (e.g., a smart phone, a Microsoft® Surface® device, a laptop computer, a notebook computer, a tablet computer such as an Apple iPad™, a netbook, etc.), a wearable computing device (e.g., a head-mounted device including smart glasses such as Google® Glass™, etc.), or a stationary computing device such as a desktop computer or PC (personal computer). Server 134 may include one or more server devices and/or other computing devices.

Local application 122 in storage 104 is an example of an application accessible by computing device 102 without communicating over a network. Local application 122 may be configured to perform data processing and/or data hosting operations when executed by a processor of computing device 102, and may provide data 132 to workflows developed using workflow designer 106 when such workflows are executed at runtime. Local application 122 may be any type of local application or service, such as a database application (e.g., QuickBooks®, a Microsoft® Excel® spreadsheet), an e-mail application (e.g., Microsoft® Outlook®), a productivity application (e.g., Microsoft® Word®, Microsoft® PowerPoint®, etc.), or another type of application. Although FIG. 1 shows a single local application, any number of local applications may be present at computing device 102, including numbers in the tens, hundreds, or greater numbers.

First and second network-based applications 124A and 124B are examples of network-based applications, which in some instances may be referred to as “cloud” applications or services. Network-based applications 124A and 124B are accessible by computing device 102 over network 126, may be configured to perform data processing and/or data hosting operations, and may provide data 130A and 130B, respectively, to workflows created using workflow designer 106 when such workflows are executed at runtime. Network-based applications 124A and 124B may each be any type of network-accessible applications or services, such as database applications, social networking applications, messaging applications, financial services applications, news applications, search applications, productivity applications, cloud storage applications, file hosting applications, etc. Examples of such applications include a network-accessible SQL (structured query language) database, Salesforce.com™, Facebook®, Twitter®, Instagram®, Yammer®, LinkedIn®, Yahoo!® Finance, The New York Times® (at www.nytimes.com), Google™ search, Microsoft® Bing®, Google Docs™, Microsoft® Office 365®, Dropbox®, etc. Although FIG. 1 shows two network-based applications, any number of network-based applications may be accessible over network 126, including numbers in the tens, hundreds, thousands, or greater numbers.

Note that data 130A, data 130B, and data 132 may each include any type of data, including messages, notifications, calculated data, retrieved data, structured data, unstructured data, and/or any other type of information requested or usable by a workflow.

Computing device 102 and server 134 may each include at least one wired or wireless network interface that enables communications with each other and with network-based applications 124A and 124B over network 126. Examples of such a network interface include an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, a near field communication (NFC) interface, etc. Further examples of network interfaces are described elsewhere herein. Examples of network 126 include a local area network (LAN), a wide area network (WAN) such as the Internet, a personal area network (PAN), and/or a combination of communication networks.

Workflow designer 106 is configured to be operated/interacted with to create applications in the form of workflows. For instance, a developer may access workflow designer 106 by interacting with an application at computing device 102 that is capable of accessing a network-based application, such as browser 136. The developer may use browser 136 to traverse a network address (e.g., a uniform resource locator) to workflow designer 106, which invokes a workflow designer GUI 116 (e.g., a web page) in a browser window 114. The developer is enabled to interact with workflow designer GUI 116 to develop a workflow.

As shown in FIG. 1, workflow designer 106 includes a UI generator 110 and a workflow logic generator 112. UI generator 110 is configured to transmit workflow GUI information 140 (e.g., one or more web pages, image content, etc.) to browser 136 to be displayed as workflow designer GUI 116 within browser window 114 in display screen 108. Workflow designer GUI 116 may be interacted with by a developer to select and configure workflow steps into a workflow. For example, the developer may insert and sequence a plurality of workflow steps in workflow designer GUI 116, with one or more of the steps being associated with a local or network-based application. Browser 136 stores the selected workflow steps, corresponding configuration information, and workflow step sequence information as constructed workflow information 138. Constructed workflow information 138 is transmitted to workflow logic generator 112 at server 134. Workflow logic generator 112 generates workflow logic 120 based on the assembled workflow represented by constructed workflow information 138. The workflow represented by workflow logic 120 may subsequently be invoked for execution by an end user.

During runtime execution of the workflow, workflow logic 120 may invoke operation of one or more local or network-based applications associated with the workflow steps of workflow logic 120. Each workflow step may receive input data. Such input data may include, for example, data 132 from local application 122, data 130A from network-based application 124A, data 130B from network-based application 124B, data from another application, and/or data from another workflow step of workflow logic 120.

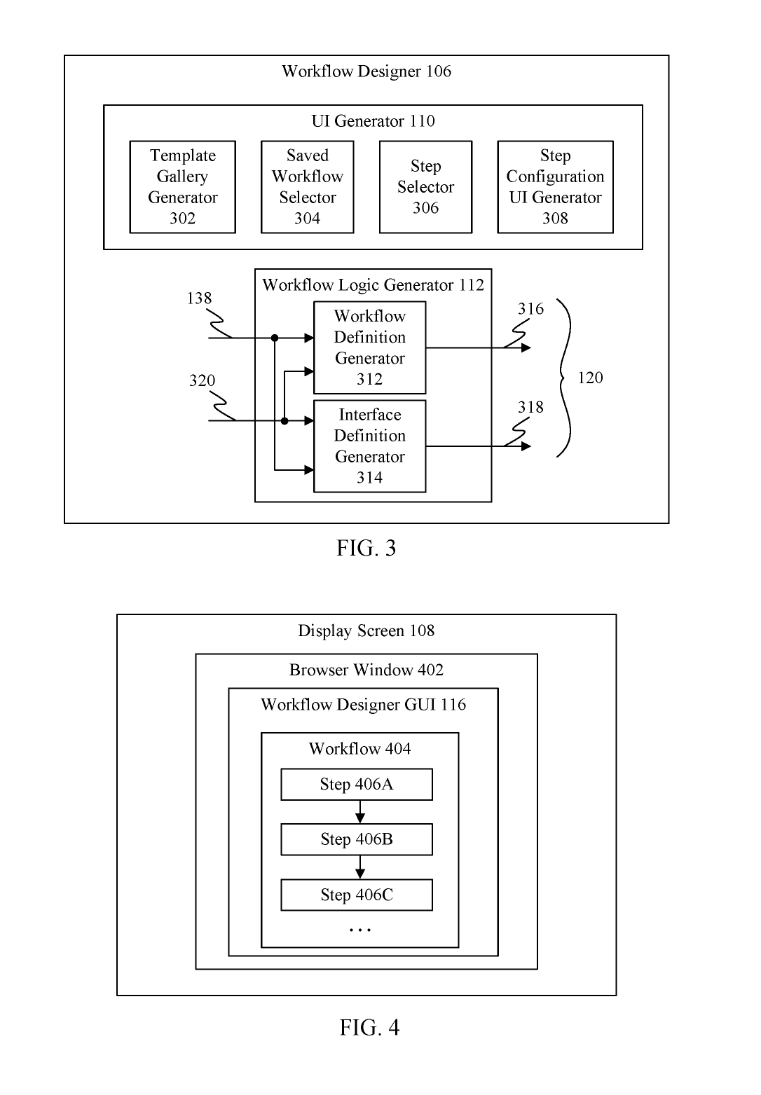

Workflow designer 106 may operate in various ways, to enable development of a workflow. For instance, in embodiments, workflow designer 106 may operate in accordance with flowchart 200 of FIG. 2. In particular, flowchart 200 depicts a process for development of workflows, according to an example embodiment. Flowchart 200 and workflow designer 106 are described as follows with respect to FIGS. 3 and 4. FIG. 3 is a block diagram of workflow designer 106, according to an example embodiment. As shown in FIG. 3, workflow designer 106 includes UI generator 110 and workflow logic generator 112. UI generator 110 includes a template gallery generator 302, a saved workflow selector 304, a step selector 306, and a step configuration UI generator 308. Workflow logic generator 112 includes a workflow definition generator 312 and an interface definition generator 314. FIG. 4 is a block diagram of display screen 108, illustrating an example of workflow designer GUI 116 displayed in browser window 402 on display screen 108, according to an example embodiment

Flowchart 200 of FIG. 2 begins with step 202. In step 202, development of a workflow is initiated. For example, in an embodiment, workflow designer 106 may be invoked by a developer interacting with browser 136 at computing device 102. The developer may traverse a link or other network address directed to workflow designer 106 at server 134, to invoke workflow designer 106, causing workflow designer 106 to provide workflow GUI information 140 (e.g., one or more web pages, image content, etc.) to browser 136 to be displayed as workflow designer GUI 116 in display screen 108 in browser window 114. Once invoked, the developer may open an existing workflow for further development, or may begin developing a new workflow.

In one example, a displayed page of workflow designer GUI 116 may display a template gallery generated by template gallery generator 302. The template gallery may include a plurality of selectable workflow templates, each of which includes one or more pre-selected workflow steps that are suitable for further configuration by a developer. The workflow templates may be stored in workflow library 118, and accessed for display by workflow designer GUI 116. The developer may select one of the workflow templates for inclusion in her workflow, and may proceed with configuring the contents of the workflow template, and/or may add additional workflow steps to the workflow steps of the workflow template to generate a more complex workflow.

For instance, in the example of FIG. 4, steps 406A and 406B may have been included in a workflow template placed in workflow 404, and step 406C may have been subsequently added (e.g., via selection from a menu or other list of workflow steps).

In another example, saved workflow selector 304 may enable the developer to select an existing, saved workflow to be opened for further editing in a displayed page of workflow designer GUI 116. The saved workflows may be stored in workflow library 118 or elsewhere. For example, saved workflow selector 306 may display a list of saved workflows, may enable navigation to a saved workflow, and/or may provide another mechanism for selecting a saved workflow for editing. The developer may then proceed with further configuring the contents of the workflow, adding workflow steps, modifying workflow steps, removing workflow steps, or the like.

In yet another example, a displayed page of workflow designer GUI 116 may provide a blank window, area, or canvas to which one or more developer-selected workflow steps may be added, ordered and configured. Such blank window, area, or canvas may be generated by UI generator 110 automatically or in response to some developer input or interaction.

In step 204, selection of one or more steps for inclusion in the workflow is enabled. When a developer is editing a workflow, step selector 306 may enable the developer to select workflow steps for inclusion in the workflow, and to order the steps. The workflow steps may be accessed by step selector 306 in workflow library 118. For instance, step selector 306 may display a menu of workflow steps, a scrollable and/or searchable list of available workflow steps, or may provide the workflow steps in another manner, and may enable the developer to select any number of workflow steps from the list for inclusion in the workflow.

In one example, step selector 306 may enable a developer to select a step that is associated with a local application, such as Microsoft® Outlook®, or a network-based application, such as Facebook®. Step selector 306 enables the steps to be chained together in a sequence, optionally with conditional steps, for inclusion in workflow logic 120.

In step 206, each of the selected steps in the workflow is enabled to be configured. In an embodiment, step configuration UI generator 308 enables configuration of each workflow step in a workflow. Step configuration UI generator 308 accesses each selected workflow step in workflow library 118 to determine the configuration of the workflow step, including all of its input parameters and any other selections or information that a developer needs to provide to the workflow step to configure it. For example, step configuration UI generator 308 may generate a UI that enables the developer to type, navigate to, use a pull-down menu, or otherwise enter input data into a text input box or other data entry element to configure (e.g., specify an input parameter of) a workflow step. The developer may configure an output parameter of a prior step to be input data for a workflow step. Step configuration UI generator 308 may enable data or other objects to be copied and pasted, dragged and dropped, or otherwise entered from elsewhere into data entry elements of a workflow step.

In step 208, workflow logic to implement the workflow is generated. In an embodiment, workflow logic generator 112 is configured to package and generate workflow logic 120 based on constructed workflow information 138 when the developer indicates the workflow is finished, such as when the developer interacts with workflow designer GUI 116 to save the workflow. As shown in FIG. 3, workflow logic generator 112 receives constructed workflow information 138. Constructed workflow information 138 indicates which workflow steps have been inserted into the workflow, their input parameter values, and their sequencing. Workflow logic generator 112 also receives selected workflow logic 320, which is the workflow logic for each workflow step of the workflow as indicated in constructed workflow information 138. In one example, workflow logic generator 112 retrieves workflow logic from workflow library 118 for each workflow step indicated in constructed workflow information 138, to receive selected workflow logic 320. Workflow logic generator 112 generates workflow logic 120 for the workflow based on constructed workflow information 138 and selected workflow logic 320. For example, workflow logic generator 112 may generate workflow logic 120 in the form of an executable file, a zip file, or other form, which may be executed in a standalone fashion, may be executed in a browser, or may be executed in another manner, depending on the particular type of workflow being generated.

With reference to FIG. 3, workflow logic generator 112 may generate workflow logic 120 to include at least two components (e.g., files): workflow definition information 316 and interface definition information 318. Workflow definition information 316 includes information that defines the sequence and operation of the workflow of workflow logic (e.g., lists the workflow step operations and their ordering/sequencing) and includes the parameter values for the workflow. For example, workflow definition information 316 may be generated to contain information in the format of a JSON (JavaScript object notation) file or in another form. Interface definition information 318 includes information that defines the interfaces/parameters (e.g., inputs and outputs) of the workflow steps of the workflow. For example, interface definition information 318 may be generated to contain information in the format of a Swagger (a specification for REST (representational state transfer) web services) file or in another form. For instance, each workflow step may be represented in workflow library 118 as API (application programming interface) metadata in Swagger format, defining what are the inputs and outputs (parameters) of the workflow step, such that a service may be accessed according to the API definition. In such an implementation, the operations in the workflow definition information 316 refer to the corresponding API metadata in the interface definition information 318 to provide a complete structure of a generated workflow (e.g., each sequenced workflow step/operation defined with parameter values in the workflow definition information 316 has a corresponding API, which is defined in the interface definition information 318).

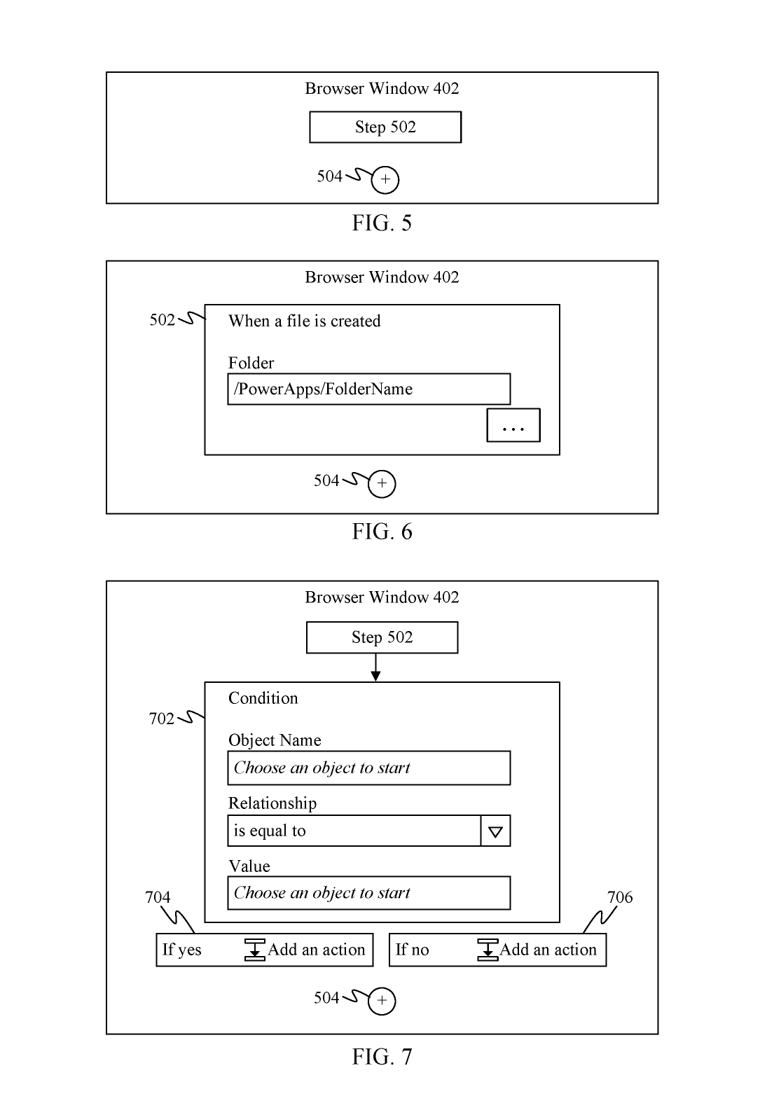

Accordingly, flowchart 200 and workflow designer 106 enable a developer to create workflows. FIGS. 5-8 show views of an exemplary workflow in various phases of development using a workflow designer GUI, according to example embodiments. For example, each of FIGS. 5-8 shows browser window 402 displaying a corresponding view of workflow designer GUI 116 being used to develop a workflow.

For instance, FIG. 5 shows browser window 402 including a workflow step 502 and an add interface 504. Workflow step 502 was selected by a developer to be a first step in a workflow. Add interface 504 (e.g., a button or other GUI control) may be interacted with by the developer to add further workflow steps to the workflow.

As described above, a developer is enabled to select workflow step 502 from a list or library of workflow steps, a template gallery, or elsewhere. A list, library, or gallery may include any number of workflow steps. The workflow steps may be associated with network-based applications mentioned elsewhere herein or otherwise known (e.g., Dropbox®), and/or with local applications mentioned elsewhere herein or otherwise known (e.g., Microsoft® Outlook®). Each workflow step is configured to be plugged into the workflow. Each workflow step is configured with the appropriate logic and/or interface(s) to perform its respective function(s), which may include communicating with a local or remote application. For instance, a workflow step for transmitting a query to an application (e.g., a search query to a search engine, a database query to a database, a request for data from a social networking application, etc.) may be pre-configured in terms of how to properly transmit and format such a request to the application. As another example, a workflow step for receiving a response to a request may be pre-configured in terms of how to parse the response for desired response data. As such, a developer of a workflow does not need to know how to write program code in a programming language, to interface with complex application interfaces (e.g., application programming interfaces (APIs)), or to understand network communication protocols, as the workflow steps are already set up. When a workflow step is plugged into workflow logic by a developer, the developer configures the inputs to the workflow step (as described below), and the pre-configured workflow step handles any communications with other applications.

In FIG. 6, the developer has interacted with step 502 (e.g., by mouse click, etc.) to cause step configuration UI generator 310 to generate a UI for configuration of step 502. For instance, in the example of FIG. 6, workflow step 502 is configured to perform monitoring to determine if a file has been created in a particular folder identified by the developer in a text input box (e.g., by typing, clicking on a navigator indicated by “ . . . ”, etc.). When workflow step 502 determines that a file has been added to the indicated folder, a workflow step following workflow step 502 is triggered. Thus, workflow step 502 may be considered a trigger step in this example.

For instance, in FIG. 7, the developer interacted with add interface 504 to facilitate the selection of a next workflow step 702. For instance, in an embodiment, interaction with add interface 502 invokes step selector 306 in FIG. 3, which enables the developer to select a workflow step. In the example of FIG. 7, workflow step 702 is a conditional step. In embodiments, logical elements may be selected for inclusion in a workflow, including arithmetic logic (e.g., summers, multipliers, etc.), conditional logic, etc., that operate based on variable values determined in earlier workflow steps. The condition of workflow step 702 enables the workflow to fork based on the determination of a condition (e.g., a variable value). The condition may include an object name, a relationship (e.g., a logical relationship, such as equal to, includes, not equal to, less than, greater than, etc.), and a value, which are all defined by the developer interacting with workflow step 702. Corresponding action steps may be performed depending on which way the workflow forks based on the condition.

For instance, in one illustrative example of FIG. 7, the object name may be selected (e.g., from a list of possibilities) to be a name of the created file of workflow step 502, the relationship may be “contains” (e.g., selected by a pull-down menu) and the value may be “dummyfile” (e.g., typed in by the developer). The condition evaluates to a “yes” condition if the file name contains “dummyfile,” which invokes first action workflow step 704, and evaluates to “no” condition if the file name does not contain “dummyfile,” which invokes second action workflow step 706. An action may be defined for one or both of the “yes” and “no” action workflow steps 704 and 706 by the developer, if desired.

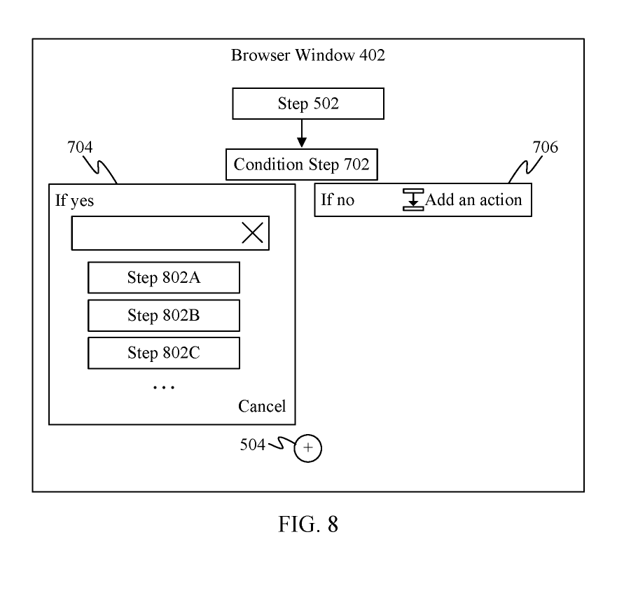

For example, in FIG. 8, the developer interacts with action workflow step 704 to define an action. In this example, the developer is defining action workflow step 704 by selecting a workflow step via step selector 306. As shown in FIG. 8, a list of workflow steps 802A, 802B, 802C is displayed, from which the developer can select a workflow step (e.g., by mouse click, etc.) to be performed for action workflow step 704. The workflow step can be a trigger step, an action step, or a condition step. After selecting the workflow step, the developer may configure the workflow step as described above. Furthermore, the developer may configure an action for workflow step 706, may add further workflow steps, etc., eventually being enabled to save the workflow.

It is noted that in some embodiments, a workflow step, such as first workflow step 502, may require credentials (e.g., a login and password) to access indicated data (e.g., to access a file at the location indicated in the text input box in FIG. 6). As such, the developer may be requested to provide credential information in association with first workflow step 502 so that when first workflow step 502 is performed during runtime, the data may be accessed. Alternatively, the credentials may be requested of a user during runtime.

### B. Example Runtime Embodiments

According to embodiments, end users may execute workflows developed as described herein. During operation, an end user may interact with a GUI of the workflow, which may lead to workflow logic being executed. The workflow logic may execute locally (e.g., in a browser) and/or at a remote service (in “the cloud”). The workflow logic may access data of one or more local or network-accessible applications as was configured by the developer. Accordingly, the workflow performs its intended functions.

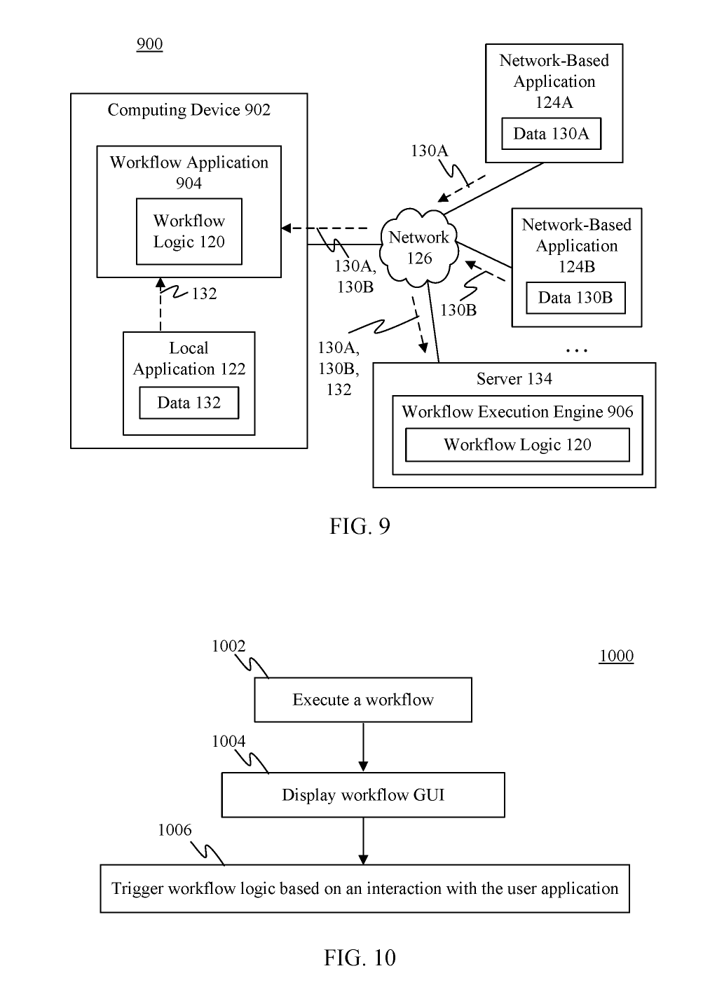

FIG. 9 is a block diagram of a system 900 for executing a workflow that includes one or more workflow steps, according to an example embodiment. As shown in FIG. 9, system 900 includes a computing device 902, first network-based application 124A, second network-based application 124B, and server 134. Computing device 902 includes a workflow application 904. Server 134 includes a workflow execution engine 906. System 900 is described as follows.

First and second network-based applications 124A and 124B are each optionally present, and whether or not such applications are communicated with will depend on the configuration of workflow logic 120. Further network-based applications may be present and communicated with, depending on the configuration of workflow logic 120.

Computing device 902 may be any type of stationary or mobile computing device described herein or otherwise known. Computing device 902 is configured to communicate with first and second network-based applications 124A and 124B and server 134 over network 126.

In one embodiment, workflows are executed at server 134 by workflow execution engine 906, and workflow application 904 is a UI application that enables a user at computing device 902 to interact with the executing workflows, such as by selecting and invoking the workflows, receiving communications from the executing workflows (e.g., messages, alerts, output data, etc.), providing requested input data to executing workflows, etc. In such an embodiment, workflow application 904 may be a workflow UI application associated with workflow execution engine 906 (e.g., workflow application 904 may be an extension of workflow execution engine 906) that may operate separate from or within a browser at computing device 902, or may be configured in another way. As shown in FIG. 9, workflow execution engine 906 may load workflow logic 120 for a selected workflow (e.g., selected from a workflow library by a user), and may execute workflow logic 120 to execute the workflow.

In another embodiment, workflow application 904 may be configured to execute workflows at computing device 902. For instance, an end user of computing device 902 may interact with a user interface of workflow application 904 to select and invoke a particular workflow (e.g., selected from a workflow library). In such embodiments, workflow logic 120 may operate separate from or in a browser at computing device 902, or may be configured in another way. As shown in FIG. 9, workflow application 904 may load workflow logic 120 for a selected workflow (e.g., selected from a workflow library by a user), and may execute workflow logic 120 to execute the workflow.

In another embodiment, a first portion of workflow logic 120 may execute in workflow application 904 at computing device 902 and a second portion of workflow logic 120 may execute in workflow execution engine 906 at server 134 and/or elsewhere.

FIG. 10 depicts a flowchart 1000 of a process for executing workflow logic 120 of a workflow, according to an example embodiment. Flowchart 1000 is described as follows with respect to system 900 of FIG. 9 for illustrative purposes.

Flowchart 1000 begins with step 1002. In step 1002, the workflow is executed. In an embodiment, an end user at computing device 902 may cause workflow logic 120 to be executed, such as by command line, by clicking/tapping or otherwise interacting with an icon or other representation of the application, by selection in a browser, or in another manner. As described above, workflow logic 120 may execute in workflow application 904 at computing device 902 and/or in workflow execution engine 906 at server 134. When executed, the workflow steps of workflow logic 120 are performed in the configured sequence. Accordingly, one or more of the workflow steps may make calls to corresponding applications/services to perform their functions, such as local application 122 (to return data 132), network-based application 124A (to return data 130A), network-based application 124B (to return data 130B), and/or other local or network-based applications.

In step 1004, the workflow GUI is displayed. Step 1004 is optional, as in some embodiments, a GUI is not displayed for a workflow. In an embodiment, the GUI may be displayed by workflow application 904 at computing device 902. When displayed, the user may interact with the GUI by reviewing displayed data (e.g., from a file, database record, spreadsheet, or other data structure read by the workflow), by entering data into the GUI (e.g., by typing, by voice, etc.), and/or by interacting with one or more controls displayed by the GUI.

In step 1006, workflow logic is triggered based on an interaction with the workflow. Step 1006 is optional in cases where one or more workflow steps of a workflow require input from a user. In such cases, the user interacts with a control in a GUI of workflow application 904 associated with a workflow step of workflow logic 120 to provide information that triggers logic of the workflow step to operate.

In this manner, workflow logic 120 performs its functions, such as processing orders, tracking information, generating messages, processing documents to generate tasks or information, collecting feedback, and/or any other functions.

### C. Example Workflow Development System Embodiments that Provide Tailored Recommendations

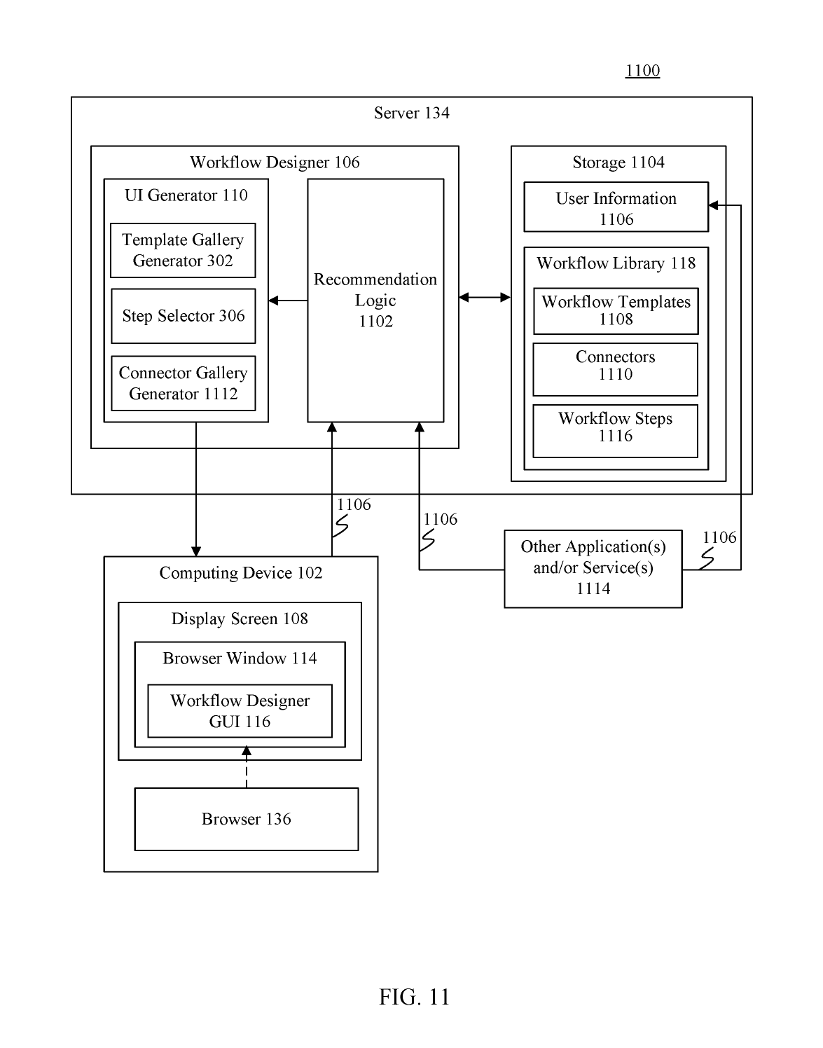

FIG. 11 is a block diagram of a workflow development system 1100 that is capable of providing tailored recommendations to a user thereof regarding workflow templates that can be used to generate workflows, applications and services around which workflows can be built, and workflow steps that may be included in a workflow under development.

Workflow development system 1100 is an example implementation of workflow development system 100 as described above in reference to FIG. 1. Accordingly, workflow development system 1100 includes workflow designer 106 that comprises UI generator 110, which in turn comprises template gallery generator 302. As was previously described, template gallery generator 302 may generate a template gallery that is displayed to a developer via workflow designer GUI 116. The template gallery may include a plurality of selectable workflow templates, each of which includes one or more pre-selected workflow steps that are suitable for further configuration by the developer. In the embodiment shown in FIG. 11, the workflow templates that are displayed to the developer are selected from among a set of workflow templates 1108 that is stored in workflow library 118. The developer may select one of the displayed workflow templates for inclusion in her workflow, and may proceed with configuring the contents of the workflow template, and/or may add additional workflow steps to the workflow steps of the workflow template to generate a more complex workflow.

In workflow development system 1100, workflow designer 106 also includes recommendation logic 1102. Recommendation logic 1102 is logic that is configured to obtain information about a user of workflow development system 1100 and, based upon such obtained information, selectively identify a set of recommended workflow templates from among workflow templates 1108. Template gallery generator 302 can then cause the set of recommended workflow templates to be presented to the user via workflow designer GUI 116. For example, by analyzing certain information about the user, recommendation logic 1102 can select workflow templates for presentation to the user that are more likely to be useful and/or of interest to the user.

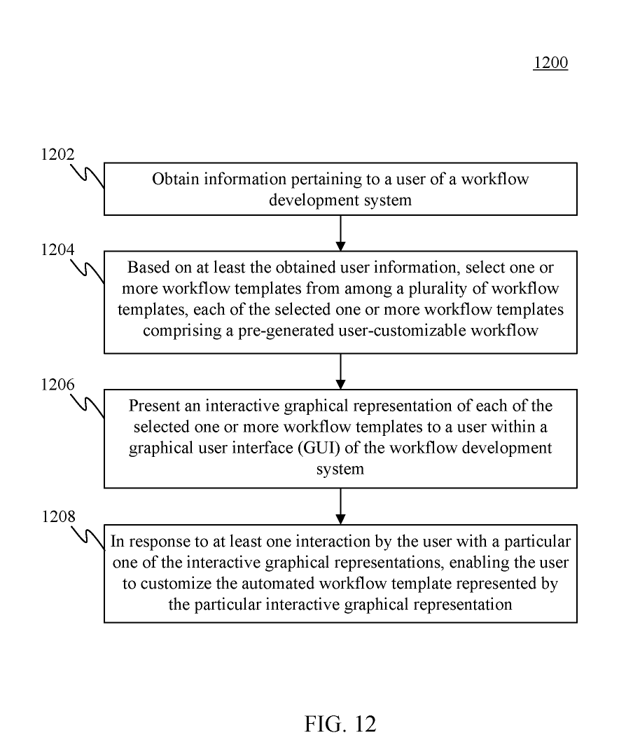

The manner in which workflow development system 1100 operates to present recommended workflow templates to a developer will now be described in reference to FIG. 12. In particular, FIG. 12 depicts a flowchart 1200 of a method for providing a user of a workflow development system with a set of recommended workflow templates for selection and configuration thereby. For the sake of illustration, the method of flowchart 1200 will be described with continued reference to the components of exemplary workflow development system 1100. However, the method is not limited to that embodiment and may be performed using other components or systems entirely.

As shown in FIG. 12, the method of flowchart 1200 begins at step 1202, in which information pertaining to a user of a workflow development system is obtained. For example, recommendation logic 1102 within workflow designer 106 may obtain information pertaining to a user of workflow development system 1100.

In FIG. 11, the information pertaining to the user of workflow development system 1100 is denoted user information 1106. Such user information 1106 may be stored in storage 1104 along with workflow library 118 and accessed therefrom by recommendation logic 1102. Storage 1104 may comprise one or more devices and/or systems that are suitable for storing data and that are accessible to workflow designer 106 and recommendation logic 1102. In FIG. 11, storage 1104 comprises part of server 134. However, in alternate embodiments storage 1104 may be separate from server 134 but connected thereto for the purposes of providing remote data storage capabilities. Depending upon the implementation, storage 1104 may comprise a cloud-based storage service, a storage device such as a network attached storage device, a disk array, a tape library, an optical or magnetic disk drive, or the like, or a storage area network. However, these are only examples and are not intended to be limiting.

User information 1106 may include a variety of information about a user. For example, user information 1106 may include one or more identifiers of the user (e.g., a name, a nickname, an account identifier (ID), an email address, or any other information suitable for identifying a particular user). User information 1106 may include an identifier of an organization to which the user belongs and/or an identifier of a department or group within an organization to which the user belongs. User information 1106 may also include historical information concerning one or more actions previously performed by the user. User information 1106 may still further include an identifier of an application or service to which the user subscribes, to which the user holds a license, that is represented by an interactive graphical representation with which the user has previously interacted, or that is invoked or interacted with by at least one workflow template or workflow with which the user has previously interacted. User information 1106 may yet further include an identifier of one or more other users that are deemed similar to the user. However, these are merely a few examples of different types of user information that may be included in user information 1106. Persons skilled in the relevant art(s) will appreciated that other types of user information not mentioned here may be included as well.

User information 1106 may be obtained in a variety of ways. For example, user information 1106 may be submitted by the user herself, e.g., through interaction with workflow designer GUI 116 or some other user interface associated with workflow development system 1100. By way of example, a user may input information about herself as part of a process of registering with or setting up an account on workflow development system 1100. This information may be collected by recommendation logic 1102 (or some other logic within workflow designer 106) and stored in storage 1104.

As another example, user information 1106 may be obtained by automatically monitoring a user's actions when interacting with workflow development system 1100. For example, recommendation logic 1102 (or some other logic within workflow designer 106) may be configured to collect various information about a user while the user is interacting with workflow development system 1100. Such user information may include, for example, search queries submitted by the user via workflow designer GUI 116 to find connectors, workflow templates, and workflow steps pursuant to generating a workflow. As used herein, the term “connector” generally refers to an application or service that may be invoked or interacted with by a workflow step via a suitable API. Such user information may also include, for example, connectors, workflow templates and workflow steps that the user has interacted with (e.g., by interacting with a graphical representation thereof) in workflow designer GUI 116. These user interactions can be recorded and analyzed to help predict the types of connectors, workflow templates and workflow steps in which a user will be interested.

As yet another example, user information 1106 may be obtained from one or more other applications and/or services 1114. For example, any of a wide variety of user information collected by other applications or services can be shared with workflow development system 1100. Such user information may include demographic information about a user, professional information about a user, user preference information, or the like. Such user information may be stored in storage 1104 or provided directly to recommendation logic 1102 in response to a request therefrom. By way of example, recommendation logic 1102 may use an API (e.g., a Microsoft® Graph API) to obtain information from Microsoft® Azure® Active Directory® concerning a user within a particular organization, such as a user's groups and organizational contacts.

In one embodiment, user information 1106 comprises a user profile associated with the user. Such user profile may be built, for example, by collecting data about a user over time, such as any or all of the various types of data described above. In accordance with such an embodiment, step 1202 comprises obtaining a user profile associated with a user of the workflow development system.

In a further embodiment, step 1202 comprises obtaining or retrieving a cookie from a computing device associated with the user. For example, recommendation logic 1102 (or some other logic within workflow designer 106) may operate to obtain or retrieve a marketing or tracking cookie that is stored on computing device 102 via browser 136. Such marketing or tracking cookie may include an identifier of the user that can then be used by recommendation logic to access further user information associated with that particular user identifier (e.g., from storage 1104 or from other application(s) and/or service(s) 1114). The marketing or tracking cookie itself may also contain other user information beyond a user identifier.

Returning now to the description of flowchart 1200, after the information pertaining to the user has been obtained at step 1202, control flows to step 1204. During step 1204, based on at least on the obtained user information, one or more workflow templates are selected from among a plurality of workflow templates, wherein each of the selected one or more workflow templates comprises a pre-generated user-customizable workflow. For example, based on at least the obtained user information, recommendation logic 1102 may select one or more workflow templates from among workflow templates 1108.

Step 1204 may be performed to select workflow template(s) that are likely to be useful and/or of interest to the user. A wide variety of different techniques may be used to determine which workflow template(s) are to be selected based on at least the user information.

For example, in an embodiment in which the obtained user information includes an organization or department to which the user belongs, recommendation logic 1102 may be configured to select the one or more workflow templates from among the plurality of workflow templates based on a frequency of use thereof within the organization or department to which the user belongs. In further accordance with this example, a set of workflow templates that are determined to be most frequently used by persons within the same organization or department as the user can be selected for presentation to the user. In still further accordance with this example, the workflow templates that are selected for presentation may be ordered or ranked for presentation from most-frequently-used to least-frequently-used.

As another example, in an embodiment in which the obtained user information includes an identifier of one or more other users that are deemed similar to the user, recommendation logic 1102 may be configured to select the one or more workflow templates from among the plurality of workflow templates based on a frequency of use thereof by the one or more other users that are deemed similar to the user. In further accordance with this example, a set of workflow templates that are determined to be most frequently used by one or more persons deemed similar to the user can be selected for presentation to the user. In still further accordance with this example, the workflow templates that are selected for presentation may be ordered or ranked for presentation from most-frequently-used to least-frequently-used.

As yet another example, in an embodiment in which the obtained user information includes an identifier of a particular application or service to which the user subscribes or to which the user holds a license, recommendation logic 1102 may select the one or more workflow templates from among the plurality of workflow templates by selecting workflow templates that include steps that invoke or interact with that particular application or service. Thus, for example, if recommendation logic 1102 determines through the obtained user information that the user subscribes or has a license to Microsoft® Office 365®, then recommendation logic 1102 can select workflow templates for presentation to the user that invoke or interact with Microsoft® Office 365®.

As still another example, in an embodiment in which the obtained user information includes historical information concerning one or more actions previously performed by the user, recommendation logic 1102 may determine that the user has previously interacted with a graphical representation of a particular application or service while interacting with workflow development system 1100 or that the user has previously interacted with a workflow template or workflow that invokes or interacts with the particular application or service. Based on such previous interaction(s), recommendation logic 1102 may select the one or more workflow templates from among the plurality of workflow templates by selecting workflow templates that include steps that invoke or interact with that particular application or service. Thus, for example, if recommendation logic 1102 determines through the obtained user information that the user previously interacted with an interactive graphical representation of Dropbox® while interacting with workflow development system 1100, then recommendation logic 1102 can select workflow templates for presentation to the user that invoke or interact with Dropbox®. Likewise, if recommendation logic 1102 determines through the obtained user information that the user previously interacted with a workflow template or workflow that invokes or interacts with Dropbox® while interacting with workflow development system 1100, then recommendation logic 1102 can select other workflow templates for presentation to the user that invoke or interact with Dropbox®.

The foregoing are merely a few examples of how recommendation logic 1102 may use the obtained user information to select a set of workflow templates for presentation to a user. These examples are not intended to be limiting and a wide variety of other methods may be used to select workflow templates that are relevant to a user based on user information pertaining to that user.

After the one or more workflow templates have been selected from among the plurality of workflow templates during step 1204, control flows to step 1206. During step 1206, an interactive graphical representation of each of the selected one or more workflow templates is presented to the user within a GUI of the workflow development system. For example, during step 1206, template gallery generator 302 may cause an interactive graphical representation of each of the selected one or more workflow templates to be presented to the user via workflow designer GUI 116.

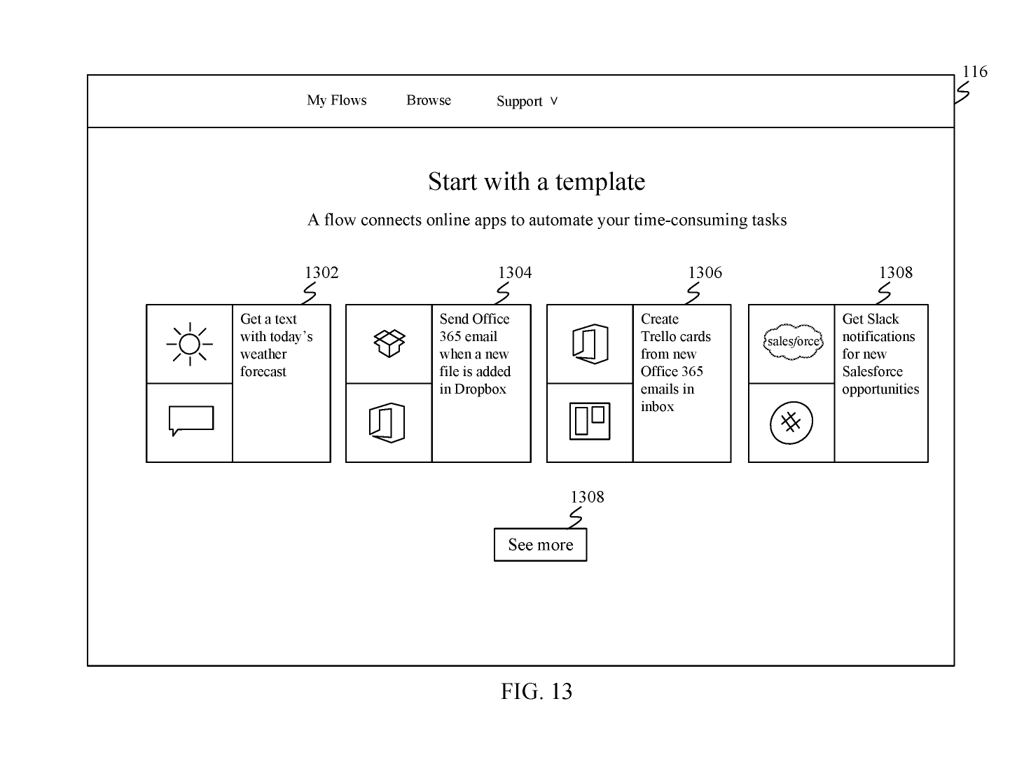

By way of example, FIG. 13 shows an example view of workflow designer GUI 116 in which interactive graphical representations corresponding to a set of workflow templates selected by recommendation logic 1102 are displayed. In the example of FIG. 13, a recommended workflow template entitled “Get a text with today's weather forecast” is represented by an interactive graphical representation 1302, a recommended workflow template entitled “Send Office 365 email when a new file is added to Dropbox” is represented by an interactive graphical representation 1304, a recommended workflow template entitled “Create Trello cards from new Office 365 emails in inbox” is represented by an interactive graphical representation 1306, and a recommended workflow template entitled “Get Slack notifications for new Salesforce opportunities” is represented by an interactive graphical representation 1308. A user may interact with each one of these interactive graphical representations, for example, by pointing and clicking on it using a mouse, touching it via a touch screen, highlighting and activating it using keyboard controls, or the like. To see additional recommended templates, the user may interact with an interactive “see more” button 1308.

In an embodiment, recommendation logic 1102 implements a ranking algorithm to assign a relevancy score to each of the selected workflow templates. For example, in one embodiment, a higher relevancy score correlates to a higher predicted degree of relevancy to the user. In accordance with such an embodiment, the interactive graphical representations of the selected workflow templates may be presented in an ordered fashion (e.g., top to bottom of a Web page, or left to right across a Web page), wherein the order of presentation is from the highest relevancy score to the lowest relevancy score. In this manner, the interactive graphical representations of the workflow templates deemed most relevant to a user will be at the top or beginning of the ordered sequence.

After the interactive graphical representations of each of the selected one or more workflow templates has been presented to the user within the GUI of the workflow development system in step 1206, control flows to step 1208. During step 1208, in response to at least one interaction by the user with a particular one of the interactive graphical representations, the user is enabled to customize the workflow template represented by the particular interactive graphical representation. For example, in response to at least one interaction by the user with a particular one of the interactive graphical representations presented in workflow designer GUI 116, UI generator 110 may enable the user to customize the workflow template represented by the particular interactive graphical representation.

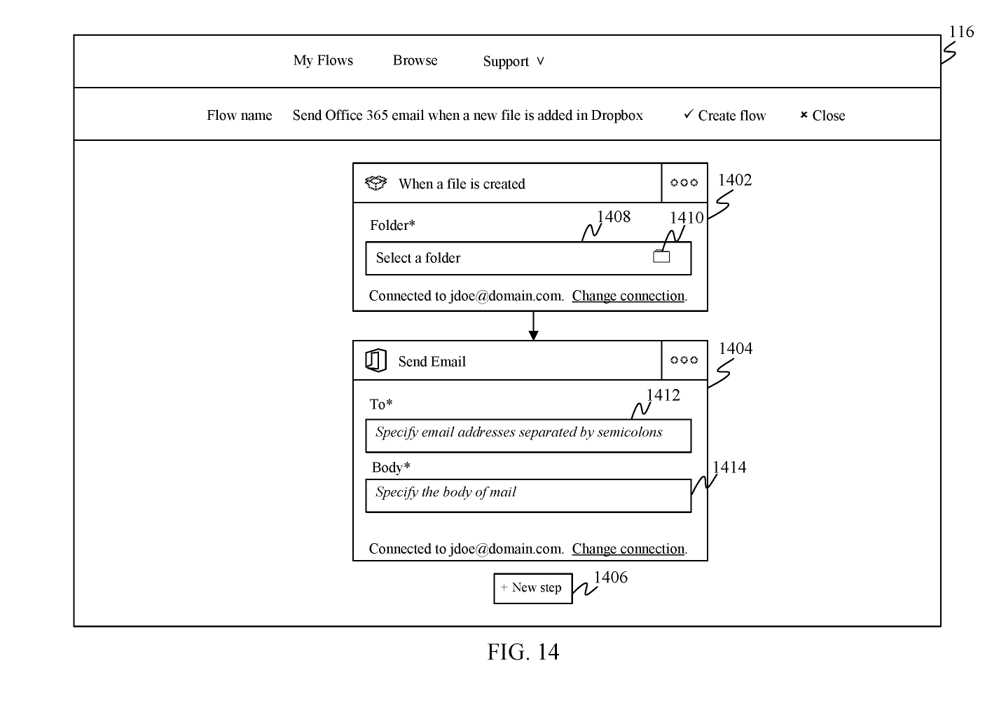

To help illustrate one implementation of step 1208, further reference is made to FIG. 13. In particular, a user may determine that she wants to work with the workflow template entitled “Send Office 365 email when a new file is added to Dropbox.” In this case, the user interacts with interactive graphical representation 1304 (e.g., by pointing and clicking on it, touching it via a touch screen, highlighting and activating it using keyboard controls or the like). In response to at least this interaction with workflow designer GUI 116 (and optionally one or more additional interactions), UI generator 110 causes the user to be provided with a new view of workflow designer GUI 116. This new view is shown in FIG. 14. In particular, FIG. 14 shows an example view of workflow designer GUI 116 in which the user is enabled to customize the workflow template represented by interactive graphical representation 1304.

As shown in FIG. 14, the workflow template selected by the user is now represented as a series of discrete and customizable steps including a first workflow step 1402 and a second workflow step 1404. First workflow step 1402 may be thought of as a trigger step, since it is activated at runtime by the occurrence of a triggering event. In this case, first workflow step 1402 is activated by the creation of a file in a certain file system folder. Here, the user is enabled to select the relevant folder by typing the name of the folder in a data entry box 1408 or by activating a browsing control 1410 that further enables the user to search for and select the folder from within a file system directory. Thus, the user is enabled to customize first workflow step 1402.

Second workflow step 1404 may be thought of as an action step, since it causes an action to be performed at runtime in response to the execution of the trigger step. In this case, the action is sending an email. Here, the user is enabled to add the email address of any intended recipient of the email to a data entry box 1412 and is further enabled to enter the body of the email into another data entry box 1414. Thus, the user is also enabled to customize second workflow step 1404.

As further shown in FIG. 14, the example view of workflow designer GUI 116 further includes a “new step” button 1406 that a user may interact with to cause additional steps to be added to the workflow under development.

As was discussed above in Section II.A, once the user has customized the workflow template (e.g., by configuring steps, adding steps, or the like), the user may then save the workflow. In response to saving the workflow, workflow logic generator 112 may package and generate workflow logic 120 based on constructed workflow information 138 associated with the workflow. This workflow logic 120 may then be executed at runtime to cause the workflow to perform its intended functions.

Thus, the method of flowchart 1200 enables a workflow development system to present a user thereof with a set of recommended workflow templates that are likely to be useful and/or of interest to the user in developing fully-customized workflows. This can improve the user experience when using the workflow development system because the user is enabled to more quickly locate desired workflow templates than she otherwise would be. This feature can also help enlighten the user by making the user aware of useful workflow templates that she might otherwise be unaware of. This feature can also serve to improve the performance of the underlying computers upon which the workflow development system is implemented, in that the user is enabled to develop a desired workflow more quickly, thereby conserving computing resources such as power, processor cycles, network bandwidth, and the like.

In addition to presenting a user with recommended workflow templates, embodiments of a workflow development system may also present a user with recommended applications or services around which to build workflows. These recommended applications or services may also be referred to generally herein as “connectors.” For example, workflow development system 1100 of FIG. 11 may operate to selectively present recommended connectors to a user thereof.

To this end, UI generator 110 of workflow designer 106 may include a connector gallery generator 1112, as shown in FIG. 11. Connector gallery generator 1112 comprises logic configured to generate a connector gallery that is displayed to a developer via workflow designer GUI 116. The connector gallery may include a plurality of interactive graphical representations (e.g., icons and/or text) of connectors. When a developer interacts with a particular one of the interactive graphical representations, template gallery generator 302 will then be called to present the developer with a set of workflow templates that invoke or interact with the corresponding connector. For example, if the developer interacts with an interactive graphical representation of a Facebook® connector within the connector gallery, then template gallery generator 302 will cause a gallery of workflow templates to be presented that each invoke or interact with Facebook®. The developer may select one of the displayed workflow templates for inclusion in her workflow, and may proceed with configuring the contents of the workflow template, and/or may add additional workflow steps to the workflow steps of the workflow template to generate a more complex workflow as was previously described.

In further accordance with this embodiment, recommendation logic 1102 is configured to obtain information about a user of workflow development system 1100 and, based upon such obtained information, selectively identify a set of recommended connectors from among a plurality of connectors 1110 (stored, e.g., in workflow library 118) that connector gallery generator 1112 can then cause to be presented within workflow designer GUI 116. For example, by analyzing certain information about the user, recommendation logic 1102 can select connectors for presentation to the user that are more likely to be useful and/or of interest to the user.

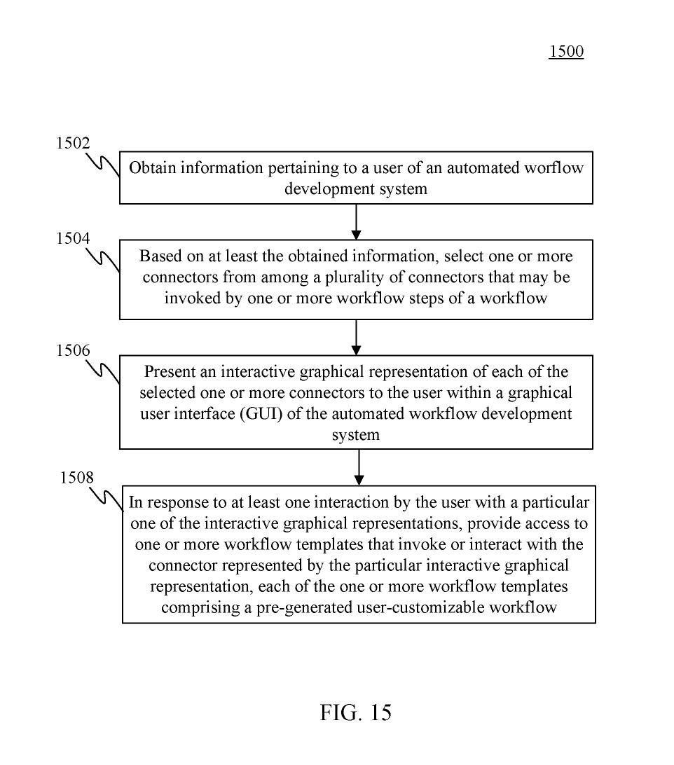

The manner in which workflow development system 1100 operates to present recommended connectors to a developer will now be described in reference to FIG. 15. In particular, FIG. 15 depicts a flowchart 1500 of a method for providing a user of a workflow development system with a set of recommended applications or services (generally referred to as connectors) around which to build a workflow, according to an example embodiment. For the sake of illustration, the method of flowchart 1500 will be described with continued reference to the components of exemplary workflow development system 1100. However, the method is not limited to that embodiment and may be performed using other components or systems entirely.

As shown in FIG. 15, the method of flowchart 1500 begins at step 1502, in which information pertaining to a user of a workflow development system is obtained. For example, recommendation logic 1102 within workflow designer 106 may obtain information pertaining to a user of workflow development system 1100. Various types of user information that may be obtained and various means for obtaining it were described in above in reference to user information 1106 of FIG. 11 and step 1202 of FIG. 12 and, thus, that description will not be repeated here for the sake of brevity.

After the information pertaining to the user has been obtained at step 1502, control flows to step 1504. During step 1504, based on at least on the obtained user information, one or more connectors are selected from among a plurality of connectors, wherein each of the selected one or more connectors comprises an application or service that may be invoked or interacted with by a workflow. For example, based on at least the obtained user information, recommendation logic 1102 may select one or more connectors from among connectors 1110.

Step 1504 may be performed to select connector(s) that are likely to be useful and/or of interest to the user. A wide variety of different techniques may be used to determine which connector(s) are to be selected based on at least the user information.

For example, in an embodiment in which the obtained user information includes an organization or department to which the user belongs, recommendation logic 1102 may be configured to select the one or more connectors from among the plurality of connectors based on a frequency of selection thereof within the organization or department to which the user belongs. In further accordance with this example, a set of connectors that are determined to be most frequently selected by persons within the same organization or department as the user can be selected for presentation to the user. In still further accordance with this example, the connectors that are selected for presentation may be ordered or ranked for presentation from most-frequently-selected to least-frequently-selected.

As another example, in an embodiment in which the obtained user information includes an identifier of one or more other users that are deemed similar to the user, recommendation logic 1102 may be configured to select the one or more connectors from among the plurality of connectors based on a frequency of selection thereof by the one or more other users that are deemed similar to the user. In further accordance with this example, a set of connectors that are determined to be most frequently selected by one or more persons deemed similar to the user can be selected for presentation to the user. In still further accordance with this example, the connectors that are selected for presentation may be ordered or ranked for presentation from most-frequently-selected to least-frequently-selected.

As yet another example, in an embodiment in which the obtained user information includes an identifier of a particular application or service to which the user subscribes or to which the user holds a license, recommendation logic 1102 may select the one or more connectors from among the plurality of workflow templates by selecting the connector corresponding to that particular application or service. Thus, for example, if recommendation logic 1102 determines through the obtained user information that the user subscribes or has a license to Microsoft® Office 365®, then recommendation logic 1102 can select a Microsoft® Office 365® connector for presentation to the user within a connector gallery.

As still another example, in an embodiment in which the obtained user information includes historical information concerning one or more actions previously performed by the user, recommendation logic 1102 may determine that the user has previously interacted with a graphical representation of a particular application or service while interacting with workflow development system 1100 or that the user has previously interacted with a workflow template or workflow that invokes or interacts with the particular application or service. Based on such previous interaction(s), recommendation logic 1102 may select the one or more connectors from among the plurality of connectors by selecting the connector that corresponds to the particular application or service. Thus, for example, if recommendation logic 1102 determines through the obtained user information that the user previously interacted with an interactive graphical representation of Dropbox® while interacting with workflow development system 1100, then recommendation logic 1102 can select a Dropbox® connector for presentation to the user within a connector gallery. Likewise, if recommendation logic 1102 determines through the obtained user information that the user previously interacted with a workflow template or workflow that invokes or interacts with Dropbox® while interacting with workflow development system 1100, then recommendation logic 1102 can select a Dropbox® connector for presentation to the user within a connector gallery.

The foregoing are merely a few examples of how recommendation logic 1102 may use the obtained user information to select a set of connectors for presentation to a user. These examples are not intended to be limiting and a wide variety of other methods may be used to select workflow templates that are relevant to a user based on user information pertaining to that user.

After the one or more connectors have been selected from among the plurality of connectors during step 1504, control flows to step 1506. During step 1506, an interactive graphical representation of each of the selected one or more connectors is presented to the user within a GUI of the workflow development system. For example, during step 1506, connector gallery generator 1112 may cause an interactive graphical representation of each of the selected one or more connectors to be presented to the user via workflow designer GUI 116.

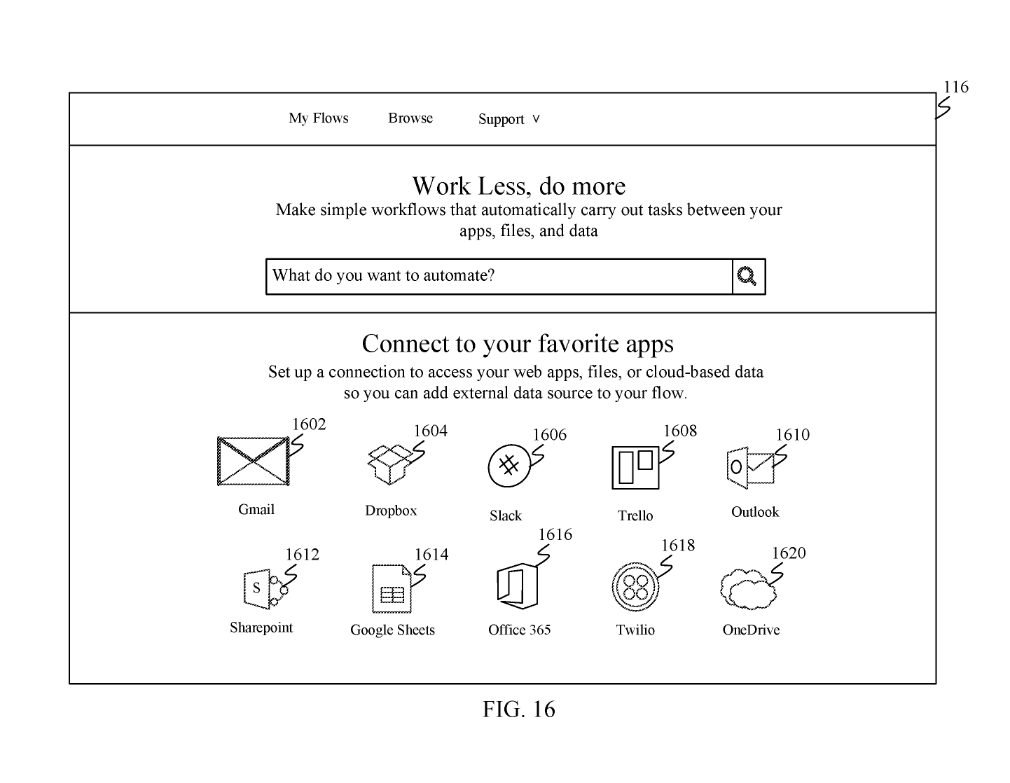

By way of example, FIG. 16 shows an example view of workflow designer GUI 116 in which interactive graphical representations corresponding to a set of connectors selected by recommendation logic 1102 are displayed. In the example of FIG. 16, a recommended connector Gmail™ is represented by interactive graphical representation 1602, a recommended connector Dropbox® is represented by an interactive graphical representation 1604, a recommended connector Slack® is represented by an interactive graphical representation 1606, a recommended connector Trello® is represented by an interactive graphical representation 1608, a recommended connector Outlook® is represented by an interactive graphical representation 1610, a recommended connector Sharepoint® is represented by an interactive graphical representation 1612, a recommended connector Google Sheets™ is represented by an interactive graphical representation 1614, a recommended connector Office 365® is represented by an interactive graphical representation 1616, a recommended connector Twilio® is represented by an interactive graphical representation 1618 and a recommended connector OneDrive® is represented by an interactive graphical representation 1620. A user may interact with each one of these interactive graphical representations, for example, by pointing and clicking on it using a mouse, touching it via a touch screen, highlighting and activating it using keyboard controls, or the like.

In an embodiment, recommendation logic 1102 implements a ranking algorithm to assign a relevancy score to each of the selected connectors. For example, in one embodiment, a higher relevancy score correlates to a higher predicted degree of relevancy to the user. In accordance with such an embodiment, the interactive graphical representations of the selected connectors may be presented in an ordered fashion (e.g., top to bottom of a Web page, or left to right across a Web page), wherein the order of presentation is from the highest relevancy score to the lowest relevancy score. In this manner, the interactive graphical representations of the connectors deemed most relevant to a user will be at the top or beginning of the ordered sequence.

After the interactive graphical representations of each of the selected one or more connectors has been presented to the user within the GUI of the workflow development system in step 1506, control flows to step 1508. During step 1508, in response to at least one interaction by the user with a particular one of the interactive graphical representations, access is provided to one or more workflow templates that invoke or interact with the connector represented by the particular interactive graphical representation, wherein each of the one or more workflow templates comprises a pre-generated user-customizable workflow. For example, in response to at least one interaction by the user with a particular one of the interactive graphical representations presented in workflow designer GUI 116, template gallery generator 302 may present one or more workflow templates within GUI 116 that invoke or interact with the connector associated with the particular one of the interactive graphical representations.

To help illustrate step 1508, further reference is made to FIG. 16. In particular, a user may determine that she wants to build a workflow that invokes or interacts with one or more features or operations associated with the connector Office 365®. In this case, the user interacts with interactive graphical representation 1616 (e.g., by pointing and clicking on it, touching it via a touch screen, highlighting and activating it using keyboard controls or the like). In response to this interaction with workflow designer GUI 116 (and optionally one or more additional interactions), template gallery generator 302 causes the user to be provided with a new view of workflow designer GUI 116. This new view includes interactive graphical representations of one or more workflow templates, wherein each workflow template includes at least one step that invokes or interacts with Office 365®. The new view may be similar to the view shown in FIG. 13, except that all of the workflow templates represented therein would invoke or interact with Office 365®. As was previously described, the user can then select a workflow template and use it to begin building a customized workflow.

Thus, the method of flowchart 1500 enables a workflow development system to present a user thereof with a set of recommended applications and services that are likely to be useful and/or of interest to the user in developing fully-customized workflows. This can improve the user experience when using the workflow development system because the user is enabled to more quickly locate workflow templates that invoke or interact with desired applications and services than she otherwise would be. This feature can also help enlighten the user by making the user aware of applications and services (and associated workflow templates) that she might otherwise remain unaware of. This feature can also serve to improve the performance of the underlying computers upon which the workflow development system is implemented, in that the user is enabled to develop a desired workflow more quickly, thereby conserving computing resources such as power, processing cycles, network bandwidth, and the like.

In addition to presenting a user with recommended workflow templates and recommended connectors, embodiments of a workflow development system may also present a user with recommended workflow steps that can be added to a workflow under development. For example, workflow development system 1100 of FIG. 11 may operate to selectively present recommended workflow steps to a user thereof.

As shown in FIG. 11, and was previously discussed in reference to FIG. 1, workflow designer 106 includes UI generator 110, which in turn includes step selector 306. As was discussed above, in certain embodiments, step selector 306 may be invoked to present a developer with a list of workflow steps via workflow designer GUI 116, each of which may be selected for insertion into a workflow under development. In an embodiment that will now be described, recommendation logic 1102 is configured to obtain information about a user and/or information about one or more workflow steps previously included in a workflow under development, and based on such obtained information, selectively identify a set of recommended workflow steps from among a plurality of workflow steps 1116 (stored, e.g., in workflow library 118) that step selector 306 can then cause to be presented within workflow designer GUI 116. For example, by analyzing certain information about the user or about the workflow steps already included in a workflow under development, recommendation logic 1102 can select workflow steps for presentation to the user that are more likely to be useful and/or of interest to the user.

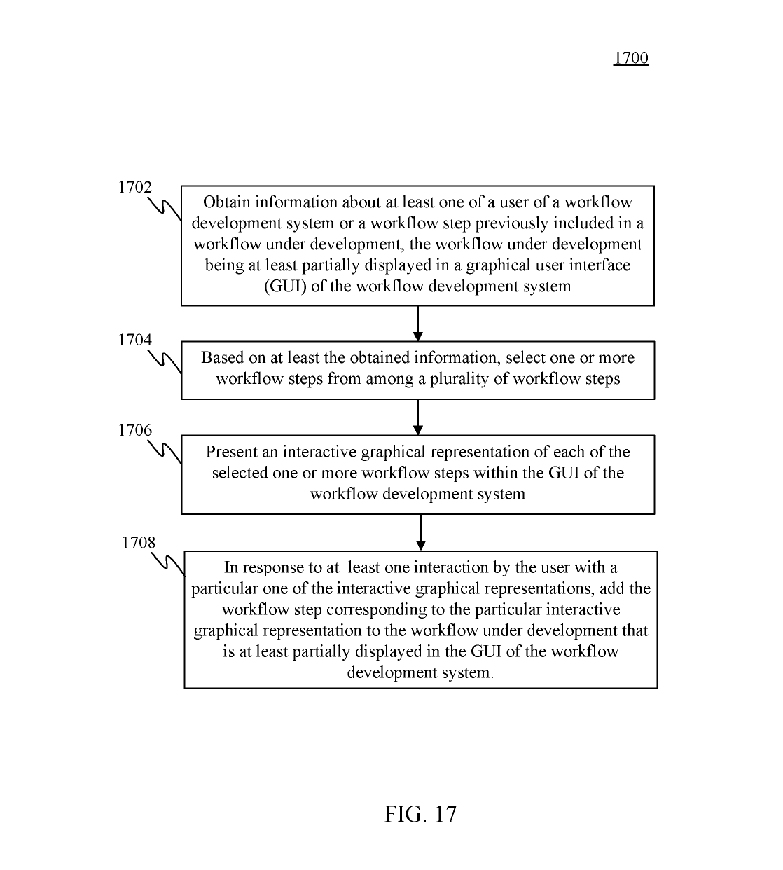

The manner in which workflow development system 1100 operates to present recommended workflow steps to a developer will now be described in reference to FIG. 17. In particular, FIG. 17 depicts a flowchart 1700 of a method for providing a user of a workflow development system with a set of recommended workflow steps for inclusion in a workflow under development, according to an example embodiment. For the sake of illustration, the method of flowchart 1700 will be described with continued reference to the components of exemplary workflow development system 1100. However, the method is not limited to that embodiment and may be performed using other components or systems entirely.

As shown in FIG. 17, the method of flowchart 1700 begins at step 1702, in which information about at least one of a user of a workflow development system or a workflow step previously included in a workflow under development is obtained, wherein the workflow under development is at least partially displayed in a GUI of the workflow development system. For example, recommendation logic 1102 within workflow designer 106 may obtain information pertaining to a user of workflow development system 1100. Various types of user information that may be obtained and various means for obtaining it were described in above in reference to user information 1106 of FIG. 11 and step 1202 of FIG. 12 and, thus, that description will not be repeated here for the sake of brevity.

As a further example, recommendation logic 1102 may also obtain information pertaining to at least one workflow step previously included in a workflow under development, wherein the workflow under development is at least partially displayed in workflow designer GUI 116. Recommendation logic 1102 may obtain such information, for example, from browser 136 or from other logic within workflow designer 106 that keeps track of which workflow steps are currently included in a workflow under development. The information about the workflow step may include, for example, an identifier of an application or service invoked or interacted with by the workflow step, one or more input parameters associated with the workflow step, one or more output parameters associated with the workflow step, or the like.

After the information about at least one of the user of the workflow development system or the workflow step previously included in the workflow under development has been obtained at step 1702, control flows to step 1704. During step 1704, based on at least on the obtained information, one or more workflow steps are selected from among a plurality of workflow steps. For example, based on at least the obtained user information, recommendation logic 1102 may select one or more workflow steps from among workflow steps 1116.

Step 1704 may be performed to select workflow step(s) that are likely to be useful and/or of interest to the user. A wide variety of different techniques may be used to determine which workflow step(s) are to be selected based on at least the user information.

For example, in an embodiment in which the obtained user information includes an organization or department to which the user belongs, recommendation logic 1102 may be configured to select the one or more workflow steps from among the plurality of workflow steps based on a frequency of use thereof within the organization or department to which the user belongs. In further accordance with this example, a set of workflow steps that are determined to be most frequently used in workflows by persons within the same organization or department as the user can be selected for presentation to the user. In still further accordance with this example, the workflow steps that are selected for presentation may be ordered or ranked for presentation from most-frequently-used to least-frequently-used.

As another example, in an embodiment in which the obtained user information includes an identifier of one or more other users that are deemed similar to the user, recommendation logic 1102 may be configured to select the one or more workflow steps from among the plurality of workflow steps based on a frequency of use thereof by the one or more other users that are deemed similar to the user. In further accordance with this example, a set of workflow steps that are determined to be most frequently used in workflows by one or more persons deemed similar to the user can be selected for presentation to the user. In still further accordance with this example, the workflow steps that are selected for presentation may be ordered or ranked for presentation from most-frequently-used to least-frequently-used.

As yet another example, in an embodiment in which the obtained user information includes an identifier of a particular application or service to which the user subscribes or to which the user holds a license, recommendation logic 1102 may select the one or more workflow steps from among the plurality of workflow steps by selecting one or more workflow steps that invoke or interact with the particular application or service. Thus, for example, if recommendation logic 1102 determines through the obtained user information that the user subscribes or has a license to Microsoft® Office 365®, then recommendation logic 1102 can select workflow steps that invoke or interact with Microsoft® Office 365® for presentation to the user.

As still another example, in an embodiment in which the obtained user information includes historical information concerning one or more actions previously performed by the user, recommendation logic 1102 may determine that the user has previously interacted with a graphical representation of a particular application or service while interacting with workflow development system 1100 or that the user has previously interacted with a workflow template or workflow that invokes or interacts with the particular application or service. Based on such previous interaction(s), recommendation logic 1102 may select the one or more workflow steps from among the plurality of workflow steps by selecting one or more workflow steps that invoke or interact with the particular application or service. Thus, for example, if recommendation logic 1102 determines through the obtained user information that the user previously interacted with an interactive graphical representation of Dropbox® while interacting with workflow development system 1100, then recommendation logic 1102 can select one or more workflow steps that invoke or interact with Dropbox® for presentation to the user. Likewise, if recommendation logic 1102 determines through the obtained user information that the user previously interacted with a workflow template or workflow that invokes or interacts with Dropbox® while interacting with workflow development system 1100, then recommendation logic 1102 can select one or more workflow steps that invoke or interact with Dropbox® for presentation to the user.

The foregoing are merely a few examples of how recommendation logic 1102 may use the obtained user information to select a set of workflow steps for presentation to a user. These examples are not intended to be limiting and a wide variety of other methods may be used to select workflow templates that are relevant to a user based on user information pertaining to that user.

As noted above, recommendation logic 1102 may also use obtained information about a workflow step previously included in a workflow under development to select one or more workflow steps from among the plurality of workflow steps.

For example, in an embodiment in which the obtained information includes an identifier of an application or service invoked or interacted with by the workflow step previously included in the workflow under development, selecting the one or more workflow steps may comprise selecting one or more workflow steps that invoke or interact with the same application or service. Thus, for example, if recommendation logic 1102 determines that the previously-included workflow step invokes or interacts with Microsoft® OneDrive®, then recommendation logic 1102 can select one or more workflow steps that invoke or interact with Microsoft® OneDrive® for presentation to the user.

As another example, in an embodiment in which the obtained information includes an identifier of a particular application or service invoked or interacted with by the workflow step previously included in the workflow under development, selecting the one or more workflow steps may comprise selecting one or more workflow steps that invoke or interact with an application or service that is deemed related to the particular application or service. Thus, for example, if recommendation logic 1102 determines that the previously-included workflow step invokes or interacts with Microsoft® OneDrive®, then recommendation logic 1102 can select one or more workflow steps that invoke or interact an application or service that is deemed related to Microsoft® OneDrive® for presentation to the user. For example, recommendation logic 1102 may select one or more workflow steps that invoke or interact with an application or service that is part of a suite of products that includes Microsoft® OneDrive® but is not Microsoft® OneDrive®, or that invoke or interact with an application or service that is often used in conjunction with Microsoft® OneDrive® (e.g., as determined by automated and/or manual tracking or via some other method).

As yet another example, in an embodiment in which the obtained information includes one or more output parameters that are associated with the workflow step previously included in the workflow under development, selecting the one or more workflow steps may comprise selecting one or more workflow steps that include one or more input parameters that are deemed related to the one or more output parameters. An input parameter may be deemed related to an output parameter, for example, if it holds the same type of information (e.g., an e-mail address, a file name), the same type of data (e.g., integer value, date, time, character string), or the like. Thus, for example, if recommendation logic 1102 determines that the previously-included workflow step includes an email address or file name as an output parameter, then recommendation logic 1102 can select one or more workflow steps that consume an e-mail address or file name as an input parameter for presentation to the user. As another example, if recommendation logic 1102 determines that the previously-included workflow step includes an output parameter that comprises a date or time data type, then recommendation logic 1102 can select one or more workflow steps that consume an input parameter of the date or time data type for presentation to the user.

After the one or more workflow steps have been selected from among the plurality of workflow steps during step 1704, control flows to step 1706. During step 1706, an interactive graphical representation of each of the selected one or more workflow steps is presented to the user within a GUI of the workflow development system. For example, during step 1706, step selector 306 may cause an interactive graphical representation of each of the selected one or more workflow steps to be presented to the user via workflow designer GUI 116.

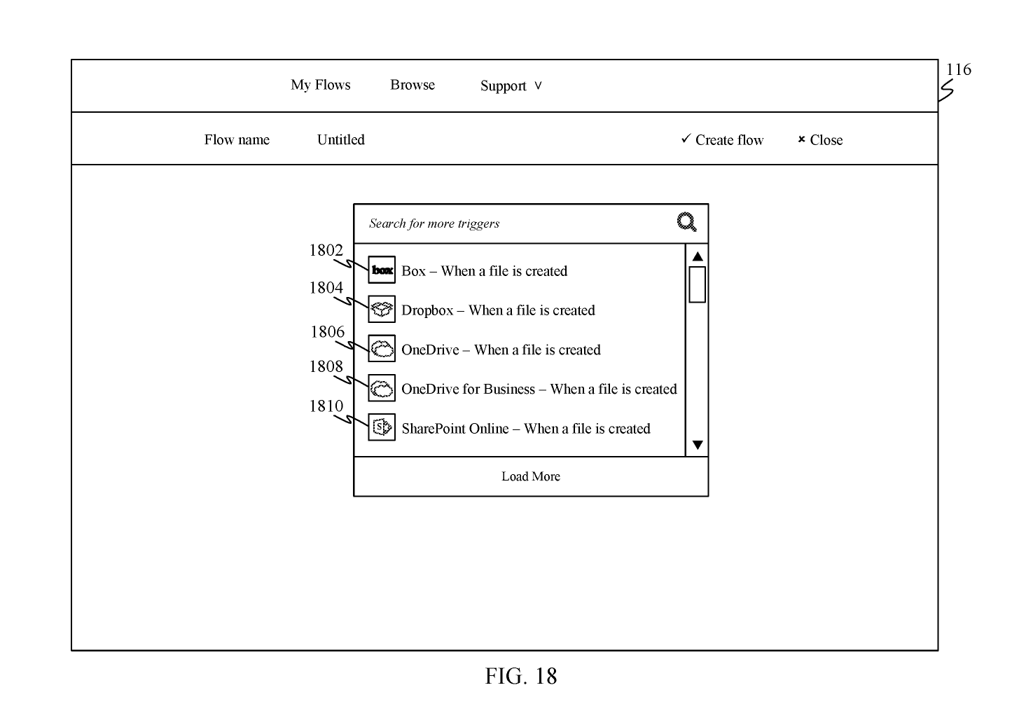

By way of example, FIG. 18 shows an example view of workflow designer GUI 116 in which interactive graphical representations associated with a set of workflow steps selected by recommendation logic 1102 are displayed. In the example of FIG. 18, a user is selecting a trigger step for inclusion in a new workflow under development. To assist the user, step selector 306 causes interactive graphical representations 1802, 1804, 1806, 1808 and 1810 of corresponding recommended workflow steps to appear within a dropdown menu within GUI 116. The user may interact with each one of these interactive graphical representations, for example, by pointing and clicking on it using a mouse, touching it via a touch screen, highlighting and activating it using keyboard controls, or the like. The user can also interact with a scroll bar and/or a “load more” button to view more interactive graphical representations of recommended workflow steps. In this example, since there are no previous steps included in the workflow under development, the recommendations may be based on user information alone.

In an embodiment, recommendation logic 1102 implements a ranking algorithm to assign a relevancy ranking to each of the selected workflow steps. For example, in one embodiment, a higher ranking correlates to a higher predicted degree of relevancy to the user. In accordance with such an embodiment, the interactive graphical representations of the selected connectors may be presented in an ordered fashion (e.g., top to bottom of a dropdown menu), wherein the order of presentation is from the highest ranked to the lowest ranked. In this manner, the interactive graphical representations of the workflow steps deemed most relevant to a user will be at the top or beginning of the ordered sequence.

After the interactive graphical representations of each of the selected one or more workflow steps has been presented to the user within the GUI of the workflow development system in step 1706, control flows to step 1708. During step 1708, in response to at least one interaction by the user with a particular one of the interactive graphical representations, the workflow step corresponding to the particular interactive graphical representation is added to the workflow under development that is at least partially displayed in the GUI of the workflow development system. For example, in response to at least one interaction by the user with a particular one of the interactive graphical representations presented in workflow designer GUI 116, UI generator 110 may cause the workflow step corresponding to the particular interactive graphical representation to be added to the workflow under development that is at least partially displayed GUI 116.

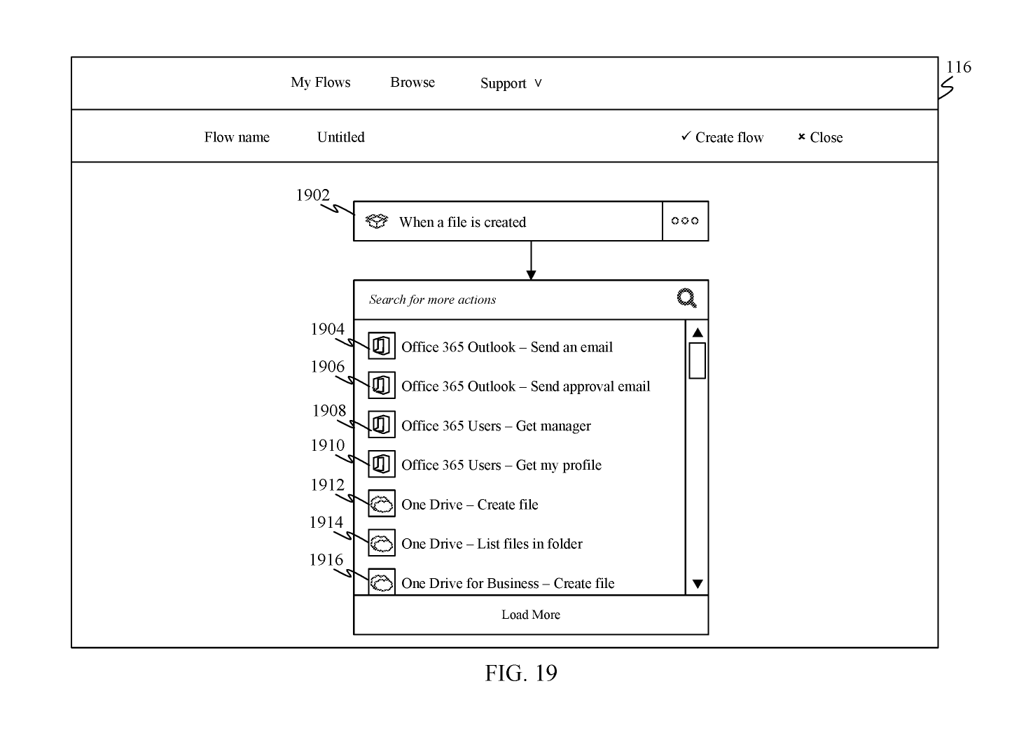

To help illustrate step 1608, further reference is made to FIG. 18. In particular, a user may determine that she wants to add the workflow step “Dropbox—When a file is created.” In this case, the user interacts with interactive graphical representation 1804 (e.g., by pointing and clicking on it, touching it via a touch screen, highlighting and activating it using keyboard controls or the like). In response to at least this interaction with workflow designer GUI 116 (and optionally one or more additional interactions), UI generator 110 causes the user to be provided with a new view of workflow designer GUI 116 in which the desired workflow step has been added to the workflow under development. This new view of workflow designer GUI 116 is shown in FIG. 19, in which it can be seen that the workflow step “Dropbox—When a file is created” has been added to the workflow under development. In FIG. 19, the workflow step “Dropbox—When a file is created” is represented by an interactive graphical representation 1902. The user can interact with interactive graphical representation 1902 to configure or remove the workflow step.

FIG. 19 also illustrates that, to assist the user in selecting an action step to follow the trigger step, interactive graphical representations associated with a new set of workflow steps selected by recommendation logic 1102 can be displayed. In the example of FIG. 19, step selector 306 causes interactive graphical representations 1904, 1906, 1908, 1910, 1912, 1914 and 1916 of corresponding recommended workflow steps to appear within a dropdown menu within GUI 116. The user may interact with each one of these interactive graphical representations, for example, by pointing and clicking on it using a mouse, touching it via a touch screen, highlighting and activating it using keyboard controls, or the like, thereby causing the workflow step corresponding to the selected interactive graphical representation to be added to the workflow under development. The user can also interact with a scroll bar and/or a “load more” button to view more interactive graphical representations of recommended workflow steps. In this example, since there is a previous step included in the workflow under development, this previous step can be taken into account when making workflow step recommendations.

Thus, the method of flowchart 1700 enables a workflow development system to present a user with a set of recommended workflow steps that are likely to be useful and/or of interest to the user in developing fully-customized workflows. This can improve the user experience when using the workflow development system because the user is enabled to more quickly locate desired workflow steps than she otherwise would be. This feature can also help enlighten the user by making the user aware of workflow steps that she might otherwise remain unaware of. This feature can also serve to improve the performance of the underlying computers upon which the workflow development system is implemented, in that the user is enabled to develop a desired workflow more quickly, thereby conserving computing resources such as power, processing cycles, network bandwidth, and the like.

In addition to presenting a user with recommended workflow templates, connectors and workflow steps, embodiments of a workflow development system may also recommend one or more output parameters of one or more first workflow steps of a workflow under development for inclusion as an input parameter for a second workflow step of the workflow under development. For example, workflow development system 1100 of FIG. 11 may operate to display a set of recommend output parameters of one or more first workflow steps to a user so that the user can select one of the recommended output parameters to be included in an input parameter for a second workflow step.

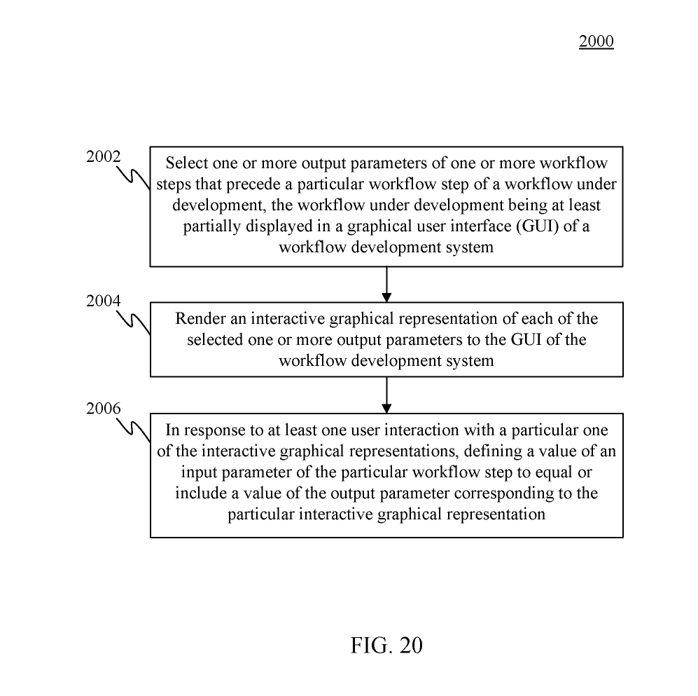

The manner in which workflow development system 1100 may operate to recommend one or more output parameters of one or more first workflow steps of a workflow under development for inclusion in an input parameter for a second workflow step of the workflow under development will now be described in reference to FIG. 20. In particular, FIG. 20 depicts a flowchart 2000 of a method for providing a user of a workflow development system with a set of recommended output parameters of one or more first workflow steps so that the user can select one of the recommended output parameters for inclusion in an input parameter for a second workflow step, according to an example embodiment. For the sake of illustration, the method of flowchart 1700 will be described with continued reference to the components of exemplary workflow development system 1100. However, the method is not limited to that embodiment and may be performed using other components or systems entirely.

As shown in FIG. 20, the method of flowchart 2000 begins at step 1702, in which one or more output parameters of one or more workflow steps that precede a particular workflow step of a workflow under development are selected, wherein the workflow under development is at least partially displayed in a GUI of a workflow development system. For example, recommendation logic 1102 within workflow designer 106 may select one or more output parameters of one or more workflow steps that precede a particular workflow step of a workflow under development, wherein the workflow under development is at least partially displayed in workflow designer GUI 116.

At step 2004, an interactive graphical representation of each of the selected one or more output parameters are rendered to the GUI of the workflow development system. For example, UI generator 110 of workflow designer 106 may cause an interactive graphical representation of each of the selected one or more output parameters to be rendered to workflow designer GUI 116.

At step 2006, in response to at least one user interaction with a particular one of the interactive graphical representations, a value of an input parameter of the particular workflow step is defined to equal or include a value of the output parameter corresponding to the particular interactive graphical representation. For example, in response to at least one user interaction with a particular one of the interactive graphical representations, workflow designer 106 may define a value of an input parameter of the particular workflow step to equal or include a value of the output parameter corresponding to the particular interactive graphical representation.

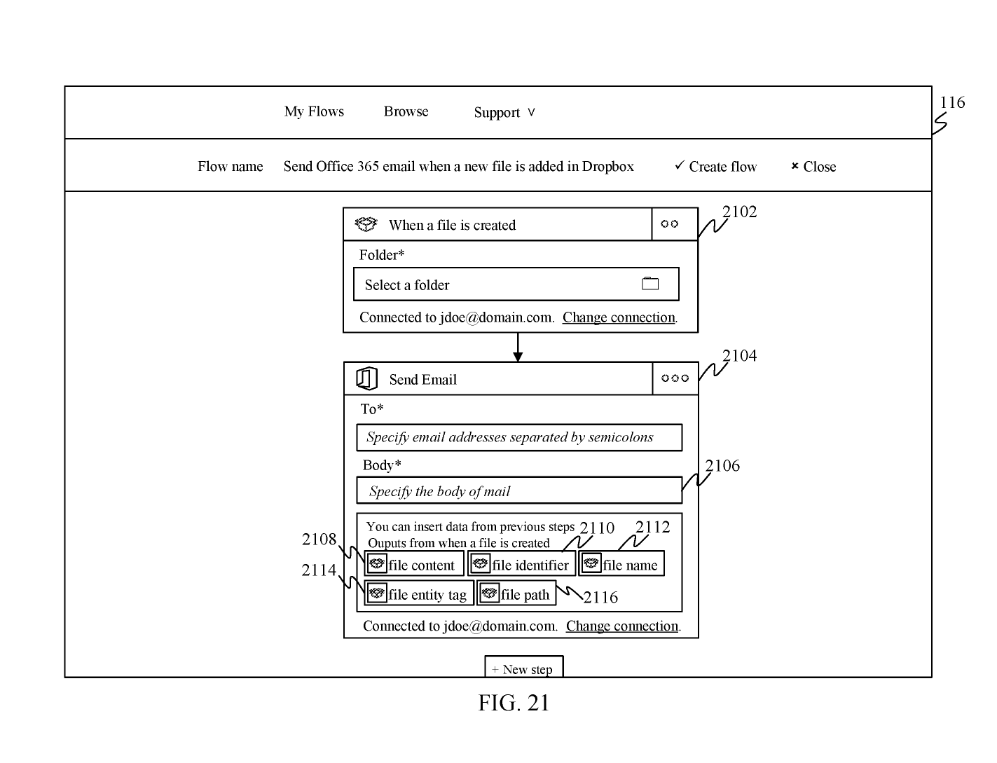

This feature will now be further explained in reference to FIG. 21. In particular, FIG. 21 shows an example view of workflow designer GUI 116 in which interactive graphical representations 2108, 2110, 2112, 2114, and 2116 of a set of recommended output parameters of a first workflow step 2102 are displayed. Here the recommended output parameters of first workflow step 2102 include “file content,” “file identifier,” “file name,” “file entity tag” and “file path.” By interacting with (e.g., by pointing and clicking on, touching via a touch screen, highlighting and activating using keyboard controls or the like) any of these interactive graphical representations, a user can cause the corresponding output parameter to be inserted as part of the input parameter “Body” of workflow step 2104. For example, by interacting with any of these interactive graphical representations, a user can cause the corresponding output parameter to be appear within data entry box 2106 which is used to specify the contents of the input parameter “Body” of workflow step 2104. This will have the following effect when the workflow is executed at runtime: the input parameter “Body” for workflow step 2104 will be populated with the value of any output parameters that were included in data entry box 2106 when the workflow was developed.

Recommendation logic 1102 may use a variety of techniques to determine which output parameters of a previous step should be recommended to a user for a defining an input parameter of a subsequent step. For example, recommendation logic 1102 may select output parameters based upon a correlation between a data type associated with the output parameters and a data type associated with the input parameter. For example, if the input parameter is of a date/time data type, then recommendation logic 1102 may recommend output parameters that are of the date/time data type. As another example, recommendation logic 1102 may select output parameters based upon a correlation between type of information associated with the output parameters and a type of information associated with the input parameter. For example, if the input parameter is a file name, then recommendation logic 1102 may recommend output parameters that represent file names. A wide variety of other techniques may be used to recommend output parameters of a previous workflow step when assisting a user in defining an input parameter of a subsequent step.

Thus, the method of flowchart 2000 enables a workflow development system to present a user with a set of recommended output parameters of previous workflow steps that are likely to be useful and/or of interest to the user in defining input parameters for a subsequent workflow step. This can improve the user experience when using the workflow development system because the user is enabled to more quickly define input parameters of workflow steps than she otherwise would be. This feature can also serve to improve the performance of the underlying computers upon which the workflow development system is implemented, in that the user is enabled to develop a desired workflow more quickly, thereby conserving computing resources such as power, processing cycles, network bandwidth, and the like.

### III. Example Mobile Device Implementation

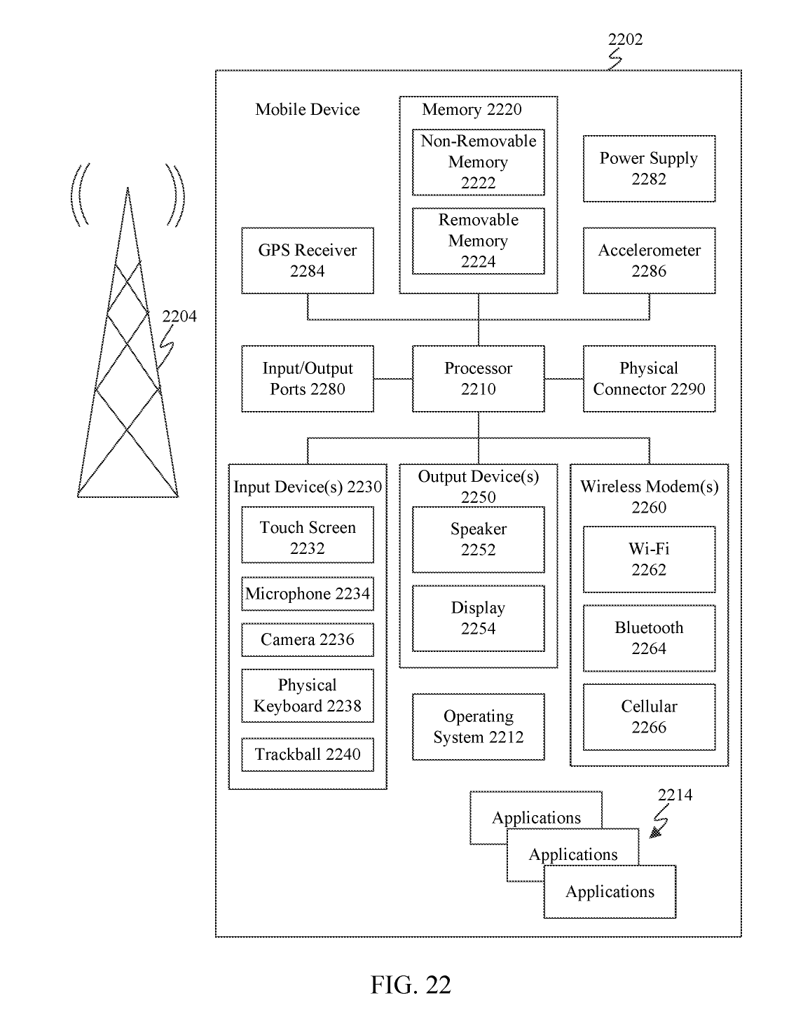

FIG. 22 is a block diagram of an exemplary mobile device 2202 that may implement embodiments described herein. For example, mobile device 2202 may be used to implement computing device 102 of FIGS. 1 and 11 or computing device 902 of FIG. 9. As shown in FIG. 22, mobile device 2202 includes a variety of optional hardware and software components. Any component in mobile device 2202 can communicate with any other component, although not all connections are shown for ease of illustration. Mobile device 2202 can be any of a variety of computing devices (e.g., cell phone, smart phone, handheld computer, Personal Digital Assistant (PDA), etc.) and can allow wireless two-way communications with one or more mobile communications networks 2204, such as a cellular or satellite network, or with a local area or wide area network.

Mobile device 2202 can include a controller or processor 2210 (e.g., signal processor, microprocessor, ASIC, or other control and processing logic circuitry) for performing such tasks as signal coding, data processing, input/output processing, power control, and/or other functions. An operating system 2212 can control the allocation and usage of the components of mobile device 2202 and provide support for one or more application programs 2214 (also referred to as “applications” or “apps”). Application programs 2214 may include common mobile computing applications (e.g., e-mail applications, calendars, contact managers, web browsers, messaging applications) and any other computing applications (e.g., word processing applications, mapping applications, media player applications).

Mobile device 2202 can include memory 2220. Memory 2220 can include non-removable memory 2222 and/or removable memory 2224. Non-removable memory 2222 can include RAM, ROM, flash memory, a hard disk, or other well-known memory devices or technologies. Removable memory 2224 can include flash memory or a Subscriber Identity Module (SIM) card, which is well known in GSM communication systems, or other well-known memory devices or technologies, such as “smart cards.” Memory 2220 can be used for storing data and/or code for running operating system 2212 and application programs 2214. Example data can include web pages, text, images, sound files, video data, or other data to be sent to and/or received from one or more network servers or other devices via one or more wired or wireless networks. Memory 2220 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

Mobile device 2202 can support one or more input devices 2230, such as a touch screen 2232, a microphone 2234, a camera 2236, a physical keyboard 2238 and/or a trackball 2240 and one or more output devices 2250, such as a speaker 2252 and a display 2254. Other possible output devices (not shown) can include piezoelectric or other haptic output devices. Some devices can serve more than one input/output function. For example, touch screen 2232 and display 2254 can be combined in a single input/output device. Input devices 2230 can include a Natural User Interface (NUI).

Wireless modem(s) 2260 can be coupled to antenna(s) (not shown) and can support two-way communications between processor 2210 and external devices, as is well understood in the art. Modem(s) 2260 are shown generically and can include a cellular modem 2266 for communicating with the mobile communication network 2204 and/or other radio-based modems (e.g., Bluetooth 2264 and/or Wi-Fi 2262). At least one of wireless modem(s) 2260 is typically configured for communication with one or more cellular networks, such as a GSM network for data and voice communications within a single cellular network, between cellular networks, or between the mobile device and a public switched telephone network (PSTN).

Mobile device 2202 can further include at least one input/output port 2280, a power supply 2282, a satellite navigation system receiver 2284, such as a Global Positioning System (GPS) receiver, an accelerometer 2286, and/or a physical connector 2290, which can be a USB port, IEEE 1394 (FireWire) port, and/or RS-232 port. The illustrated components of mobile device 2202 are not required or all-inclusive, as any components can be deleted and other components can be added as would be recognized by one skilled in the art.

In an embodiment, mobile device 2202 is configured to implement any of the above-described features of workflow development system 100 of FIG. 1 or workflow development system 1100 of FIG. 11. Computer program logic for performing the functions of these devices may be stored in memory 2220 and executed by processor 2210.

### IV. Example Computer System Implementation

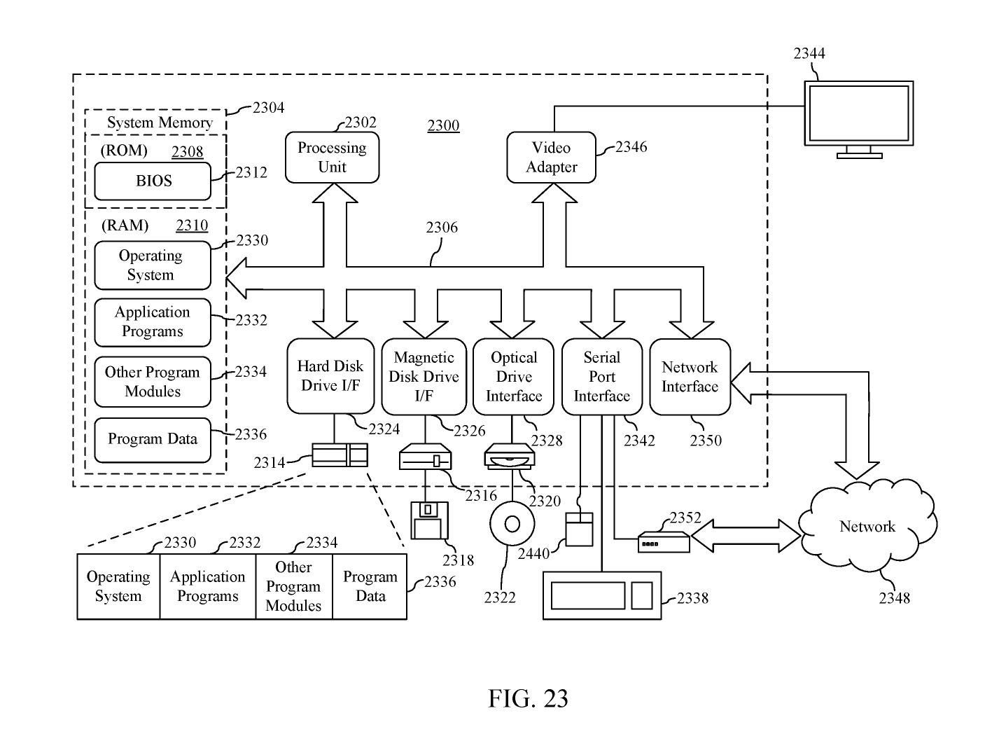

FIG. 23 depicts an example processor-based computer system 2300 that may be used to implement various embodiments described herein. For example, system 2300 may be used to implement computing device 102 or server 134 as described above in reference to FIGS. 1 and 11, or computing device 902 as described above in reference to FIG. 9. System 2300 may also be used to implement any of the steps of any of the flowcharts of FIGS. 2, 10, 12, 15, 17 and 20 as described above. The description of system 2300 provided herein is provided for purposes of illustration, and is not intended to be limiting. Embodiments may be implemented in further types of computer systems, as would be known to persons skilled in the relevant art(s).

As shown in FIG. 23, system 2300 includes a processing unit 2302, a system memory 2304, and a bus 2306 that couples various system components including system memory 2304 to processing unit 2302. Processing unit 2302 may comprise one or more circuits, microprocessors or microprocessor cores. Bus 2306 represents one or more of any of several types of bus structures, including a memory bus or memory controller, a peripheral bus, an accelerated graphics port, and a processor or local bus using any of a variety of bus architectures. System memory 2304 includes read only memory (ROM) 2308 and random access memory (RAM) 2310. A basic input/output system 2312 (BIOS) is stored in ROM 2308.

System 2300 also has one or more of the following drives: a hard disk drive 2314 for reading from and writing to a hard disk, a magnetic disk drive 2316 for reading from or writing to a removable magnetic disk 2318, and an optical disk drive 2320 for reading from or writing to a removable optical disk 2322 such as a CD ROM, DVD ROM, BLU-RAY™ disk or other optical media. Hard disk drive 2314, magnetic disk drive 2316, and optical disk drive 2320 are connected to bus 2306 by a hard disk drive interface 2324, a magnetic disk drive interface 2326, and an optical drive interface 2328, respectively. The drives and their associated computer-readable media provide nonvolatile storage of computer-readable instructions, data structures, program modules and other data for the computer. Although a hard disk, a removable magnetic disk and a removable optical disk are described, other types of computer-readable memory devices and storage structures can be used to store data, such as flash memory cards, digital video disks, random access memories (RAMs), read only memories (ROM), and the like.

A number of program modules may be stored on the hard disk, magnetic disk, optical disk, ROM, or RAM. These program modules include an operating system 2330, one or more application programs 2332, other program modules 2334, and program data 2336. In accordance with various embodiments, the program modules may include computer program logic that is executable by processing unit 2302 to perform any or all of the functions and features of computing device 102 or server 134 as described above in reference to FIGS. 1 and 11, or computing device 902 as described above in reference to FIG. 9. The program modules may also include computer program logic that, when executed by processing unit 2302, causes processing unit 2302 to perform any of the steps of any of the flowcharts of FIGS. 2, 10, 12, 15, 17 and 20 as described above.

A user may enter commands and information into system 2300 through input devices such as a keyboard 2338 and a pointing device 2340 (e.g., a mouse). Other input devices (not shown) may include a microphone, joystick, game controller, scanner, or the like. In one embodiment, a touch screen is provided in conjunction with a display 2344 to allow a user to provide user input via the application of a touch (as by a finger or stylus for example) to one or more points on the touch screen. These and other input devices are often connected to processing unit 2302 through a serial port interface 2342 that is coupled to bus 2306, but may be connected by other interfaces, such as a parallel port, game port, or a universal serial bus (USB). Such interfaces may be wired or wireless interfaces.

Display 2344 is connected to bus 2306 via an interface, such as a video adapter 2346. In addition to display 2344, system 2300 may include other peripheral output devices (not shown) such as speakers and printers.

System 2300 is connected to a network 2348 (e.g., a local area network or wide area network such as the Internet) through a network interface 2350, a modem 2352, or other suitable means for establishing communications over the network. Modem 2352, which may be internal or external, is connected to bus 2306 via serial port interface 2342.

As used herein, the terms “computer program medium,” “computer-readable medium,” and “computer-readable storage medium” are used to generally refer to memory devices or storage structures such as the hard disk associated with hard disk drive 2314, removable magnetic disk 2318, removable optical disk 2322, as well as other memory devices or storage structures such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 2332 and other program modules 2334) may be stored on the hard disk, magnetic disk, optical disk, ROM, or RAM. Such computer programs may also be received via network interface 2350, serial port interface 2342, or any other interface type. Such computer programs, when executed or loaded by an application, enable system 2300 to implement features of embodiments discussed herein. Accordingly, such computer programs represent controllers of the system 2300. Embodiments are also directed to computer program products comprising software stored on any computer useable medium. Such software, when executed in one or more data processing devices, causes a data processing device(s) to operate as described herein. Embodiments may employ any computer-useable or computer-readable medium, known now or in the future. Examples of computer-readable mediums include, but are not limited to memory devices and storage structures such as RAM, hard drives, floppy disks, CD ROMs, DVD ROMs, zip disks, tapes, magnetic storage devices, optical storage devices, MEMs, nanotechnology-based storage devices, and the like.

In alternative implementations, system 2300 may be implemented as hardware logic/electrical circuitry or firmware. In accordance with further embodiments, one or more of these components may be implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### V. Additional Example Embodiments

A method in a computing device is described herein. The method includes: obtaining information pertaining to a user of a workflow development system; based on at least the obtained information, selecting one or more workflow templates from among a plurality of workflow templates, each of the selected one or more workflow templates comprising a pre-generated user-customizable workflow; presenting an interactive graphical representation of each of the selected one or more workflow templates to the user within a graphical user interface (GUI) of the workflow development system; and in response to at least one interaction by the user with a particular one of the interactive graphical representations, enabling the user to customize the workflow template represented by the particular interactive graphical representation.

In one embodiment of the foregoing method, obtaining the information pertaining to the user of the workflow development system comprises obtaining a user profile associated with the user.

In another embodiment of the foregoing method, obtaining the information pertaining to the user of the workflow development system comprises retrieving a cookie from a computing device associated with the user.

In yet another embodiment of the foregoing method, obtaining the information pertaining to the user of the workflow development system comprises obtaining one or more of: an identifier of the user; an identifier of an organization or a department to which the user belongs; historical information concerning one or more actions previously performed by the user; an identifier of an application or service to which the user subscribes, to which the user holds a license, that is represented by an interactive graphical representation with which the user has previously interacted, or that is invoked or interacted with by at least one workflow template or workflow with which the user has previously interacted; or an identifier of one or more other users deemed similar to the user.

In further accordance with this embodiment, selecting the one or more workflow templates from among the plurality of workflow templates may comprise selecting the one or more workflow templates based on a frequency of use thereof within the organization or the department to which the user belongs.

In still further accordance with this embodiment, selecting the one or more workflow templates from among the plurality of workflow templates may comprise selecting the one or more workflows templates based on a frequency of use thereof by the other users that are deemed similar to the user.

In yet further accordance with this embodiment, selecting the one or more workflow templates from among the plurality of workflow templates may comprise selecting one or more workflow templates that invoke the application or service to which the user subscribes, to which the user holds a license, that is represented by an interactive graphical representation with which the user has previously interacted, or that is invoked or interacted with by at least one workflow template or workflow with which the user has previously interacted.

A system is also described herein. The system includes at least one processor circuit and at least one memory that stores program code configured to be executed by the at least one processor circuit. The program code includes recommendation logic and a user interface generator. The recommendation logic is configured to obtain information pertaining to a user of a workflow development system and to select, based on at least the obtained information, one or more applications or services from among a plurality of applications or services that may be invoked by one or more workflow steps of a workflow. The user interface generator is configured to present an interactive graphical representation of each of the selected one or more applications or services to the user within a graphical user interface (GUI) of the workflow development system, and, in response to at least one interaction by the user with a particular one of the interactive graphical representations, to provide access to one or more workflow templates that invoke the application or service represented by the particular interactive graphical representation, each of the one or more workflow templates comprising a pre-generated user-customizable workflow.

In one embodiment of the foregoing system, the recommendation logic is configured to obtain the information pertaining to the user of the workflow development system by obtaining a user profile associated with the user.

In another embodiment of the foregoing system, the recommendation logic is configured to obtain the information pertaining to the user of the workflow development system by retrieving a cookie from a computing device associated with the user.

In yet another embodiment of the foregoing system, the recommendation logic is configured to obtain the information pertaining to the user of the workflow development system by obtaining one or more of: an identifier of the user; an identifier of an organization or a department to which the user belongs; historical information concerning one or more actions previously performed by the user; an identifier of an application or service to which the user subscribes, to which the user holds a license, that is represented by an interactive graphical representation with which the user has previously interacted, or that is invoked or interacted with by at least one workflow template or workflow with which the user has previously interacted; or an identifier of one or more other users that are deemed similar to the user.

In further accordance with this embodiment, the recommendation logic may be configured to select the one or more applications or services from among the plurality of applications or services based on a frequency of selection thereof within the organization or the department to which the user belongs.

In still further accordance with this embodiment, the recommendation logic may be configured to select the one or more applications or services from among the plurality of applications or services based on a frequency of selection thereof by the other users that are deemed similar to the user.

In yet further accordance with this embodiment, the recommendation logic may be configured to select the one or more applications or services from among the plurality of applications or services by selecting the application or service to which the user subscribes, to which the user holds a license, that is represented by an interactive graphical representation with which the user has previously interacted, or that is invoked or interacted with by at least one workflow template or workflow with which the user has previously interacted.

A computer program product is also described herein. The computer program product comprises a computer-readable memory having computer program logic recorded thereon that when executed by at least one processor causes the at least one processor to perform a method. The method includes: obtaining information about at least one of a user of a workflow development system or a workflow step previously included in a workflow under development, the workflow under development being at least partially displayed in a graphical user interface (GUI) of the workflow development system; based on at least the obtained information, selecting one or more workflow steps from among a plurality of workflow steps; presenting an interactive graphical representation of each of the selected one or more workflow steps within the GUI of the workflow development system; and in response to at least one interaction by the user with a particular one of the interactive graphical representations of each of the selected one or more workflow steps, adding the workflow step corresponding to the particular interactive graphical representation to the workflow under development that is at least partially displayed in the GUI of the workflow development system.

In one embodiment of the foregoing computer program product, obtaining information about the workflow step previously included in the workflow under development comprises identifying an application or service invoked or interacted with by the workflow step previously included in the workflow under development, and selecting the one or more workflow steps from among the plurality of workflow steps comprises selecting one or more workflow steps that invoke or interact with the same application or service or with another application or service that is deemed related to the same application or service.

In another embodiment of the foregoing computer program product, obtaining information about the workflow step previously included in the workflow under development comprises identifying one or more output parameters that are associated with the workflow step previously included in the workflow under development, and selecting the one or more workflow steps from among the plurality of workflow steps comprises selecting one or more workflow steps having one or more input parameters that are deemed related to the one or more output parameters.

In yet another embodiment of the foregoing computer program product, the method further comprises: selecting one or more output parameters of one or more workflow steps that precede a particular workflow step of the workflow under development; rendering an interactive graphical representation of each of the selected one or more output parameters to the GUI of the workflow development system; and in response to at least one user interaction with a particular one of the interactive graphical representations of each of the selected one or more output parameters, defining a value of an input parameter of the particular workflow step to equal or include a value of the output parameter corresponding to the particular interactive graphical representation.

In further accordance with this embodiment, selecting the one or more output parameters may comprise selecting the one or more output parameters based upon a correlation between a data type associated with the one or more output parameters and a data type associated with the input parameter.

In still further accordance with this embodiment, selecting the one or more output parameters may comprise selecting the one or more output parameters based upon a correlation between a type of information associated with the one or more output parameters and a type of information associated with the input parameter.

### VI. Conclusion

While various embodiments have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method in a computing device, comprising:
obtaining information pertaining to a user of a workflow development system;
based on at least the obtained information, selecting one or more workflow templates from among a plurality of workflow templates, each of the selected one or more workflow templates comprising a pre-generated user-customizable workflow;
presenting an interactive graphical representation of each of the selected one or more workflow templates to the user within a graphical user interface (GUI) of the workflow development system; and
in response to at least one interaction by the user with a particular one of the interactive graphical representations, enabling the user to customize the workflow template represented by the particular interactive graphical representation.

2. The method of claim 1, wherein obtaining the information pertaining to the user of the workflow development system comprises obtaining a user profile associated with the user.

3. The method of claim 1, wherein obtaining the information pertaining to the user of the workflow development system comprises retrieving a cookie from a computing device associated with the user.

4. The method of claim 1, wherein obtaining the information pertaining to the user of the workflow development system comprises obtaining one or more of:
an identifier of the user;
an identifier of an organization or a department to which the user belongs;
historical information concerning one or more actions previously performed by the user;
an identifier of an application or service to which the user subscribes, to which the user holds a license, that is represented by an interactive graphical representation with which the user has previously interacted, or that is invoked or interacted with by at least one workflow template or workflow with which the user has previously interacted; or
an identifier of one or more other users deemed similar to the user.

5. The method of claim 4, wherein selecting the one or more workflow templates from among the plurality of workflow templates comprises:
selecting the one or more workflow templates based on a frequency of use thereof within the organization or the department to which the user belongs.

6. The method of claim 4, wherein selecting the one or more workflow templates from among the plurality of workflow templates comprises:
selecting the one or more workflows templates based on a frequency of use thereof by the other users that are deemed similar to the user.

7. The method of claim 4, wherein selecting the one or more workflow templates from among the plurality of workflow templates comprises:
selecting one or more workflow templates that invoke the application or service to which the user subscribes, to which the user holds a license, that is represented by an interactive graphical representation with which the user has previously interacted, or that is invoked or interacted with by at least one workflow template or workflow with which the user has previously interacted.

8. A system, comprising:
at least one processor circuit; and
at least one memory that stores program code configured to be executed by the at least one processor circuit, the program code comprising:
recommendation logic configured to obtain information pertaining to a user of a workflow development system and to select, based on at least the obtained information, one or more applications or services from among a plurality of applications or services that may be invoked by one or more workflow steps of a workflow; and
a user interface generator configured to present an interactive graphical representation of each of the selected one or more applications or services to the user within a graphical user interface (GUI) of the workflow development system, and, in response to at least one interaction by the user with a particular one of the interactive graphical representations, to provide access to one or more workflow templates that invoke the application or service represented by the particular interactive graphical representation, each of the one or more workflow templates comprising a pre-generated user-customizable workflow.

9. The system of claim 8, wherein the recommendation logic is configured to obtain the information pertaining to the user of the workflow development system by obtaining a user profile associated with the user.

10. The system of claim 8, wherein the recommendation logic is configured to obtain the information pertaining to the user of the workflow development system by retrieving a cookie from a computing device associated with the user.

11. The system of claim 8, wherein the recommendation logic is configured to obtain the information pertaining to the user of the workflow development system by obtaining one or more of:
an identifier of the user;
an identifier of an organization or a department to which the user belongs;
historical information concerning one or more actions previously performed by the user;
an identifier of an application or service to which the user subscribes, to which the user holds a license, that is represented by an interactive graphical representation with which the user has previously interacted, or that is invoked or interacted with by at least one workflow template or workflow with which the user has previously interacted; or
an identifier of one or more other users that are deemed similar to the user.

12. The system of claim 11, wherein the recommendation logic is configured to select the one or more applications or services from among the plurality of applications or services based on a frequency of selection thereof within the organization or the department to which the user belongs.

13. The system of claim 11, wherein the recommendation logic is configured to select the one or more applications or services from among the plurality of applications or services based on a frequency of selection thereof by the other users that are deemed similar to the user.

14. The system of claim 11, wherein the recommendation logic is configured to select the one or more applications or services from among the plurality of applications or services by selecting the application or service to which the user subscribes, to which the user holds a license, that is represented by an interactive graphical representation with which the user has previously interacted, or that is invoked or interacted with by at least one workflow template or workflow with which the user has previously interacted.

15. A computer program product comprising a computer-readable memory having computer program logic recorded thereon that when executed by at least one processor causes the at least one processor to perform a method, the method comprising:
obtaining information about at least one of a user of a workflow development system or a workflow step previously included in a workflow under development, the workflow under development being at least partially displayed in a graphical user interface (GUI) of the workflow development system;
based on at least the obtained information, selecting one or more workflow steps from among a plurality of workflow steps;
presenting an interactive graphical representation of each of the selected one or more workflow steps within the GUI of the workflow development system; and
in response to at least one interaction by the user with a particular one of the interactive graphical representations of each of the selected one or more workflow steps, adding the workflow step corresponding to the particular interactive graphical representation to the workflow under development that is at least partially displayed in the GUI of the workflow development system.

16. The computer program product of claim 15, wherein obtaining information about the workflow step previously included in the workflow under development comprises identifying an application or service invoked or interacted with by the workflow step previously included in the workflow under development, and wherein selecting the one or more workflow steps from among the plurality of workflow steps comprises selecting one or more workflow steps that invoke or interact with the same application or service or with another application or service that is deemed related to the same application or service.

17. The computer program product of claim 15, wherein obtaining information about the workflow step previously included in the workflow under development comprises identifying one or more output parameters that are associated with the workflow step previously included in the workflow under development, and wherein selecting the one or more workflow steps from among the plurality of workflow steps comprises selecting one or more workflow steps having one or more input parameters that are deemed related to the one or more output parameters.

18. The computer program product of claim 15, wherein the method further comprises:
selecting one or more output parameters of one or more workflow steps that precede a particular workflow step of the workflow under development;
rendering an interactive graphical representation of each of the selected one or more output parameters to the GUI of the workflow development system; and
in response to at least one user interaction with a particular one of the interactive graphical representations of each of the selected one or more output parameters, defining a value of an input parameter of the particular workflow step to equal or include a value of the output parameter corresponding to the particular interactive graphical representation.

19. The computer program product of claim 19, wherein selecting the one or more output parameters comprises:
selecting the one or more output parameters based upon a correlation between a data type associated with the one or more output parameters and a data type associated with the input parameter.

20. The computer program product of claim 19, wherein selecting the one or more output parameters comprises:
selecting the one or more output parameters based upon a correlation between a type of information associated with the one or more output parameters and a type of information associated with the input parameter.
